(19) United States
(12) Patent Application Publication
(10) Pub. No.: US 2016/0196600 A1
(43) Pub. Date: Jul. 7, 2016

(54) METHODS AND SYSTEMS FOR HARMONIZING A DÉCOR SCHEME

(71) Applicant: ART.COM, INC., Emeryville, CA (US)

(72) Inventor: Paul Golding, Cupertino, CA (US)

(21) Appl. No.: 14/591,466

(22) Filed: Jan. 7, 2015

(51) Int. Cl. G06Q 30/06; G06F 3/0484; G06F 3/0482; G06F 17/30

(52) U.S. Cl. CPC G06Q 30/0627; G06F 17/30528; G06F 3/04842; G06F 3/0482

(57) ABSTRACT

Systems and methods are disclosed for generating a harmonized set of décor accessories using one or more harmony descriptors. Some systems facilitate harmonization by receiving a representation of a plurality of décor accessories that includes metadata, creating one or more harmony descriptors from the metadata, and matching two or more décor accessories using the harmony descriptors. The harmony descriptors can identify matching décor accessories based on a subset of metadata elements of the décor accessories. Two or more metadata elements can match by being similar, identical, or complementary. Some systems automatically determine whether the metadata elements of two décor accessories match, while other systems allow a curator to determine whether two décor accessories match. Various systems allow a user or curator to select a décor accessory and, upon selection, search a harmony descriptor database for a matching décor accessory.

### RELATED FIELD

Various embodiments of the present invention generally relate to harmonizing a décor scheme, and more specifically to selecting a décor accessory from a plurality of décor accessories and identifying a set of décor accessories that match the selected décor accessory.

### BACKGROUND

Current tools for finding décor accessories such as art, rugs, décorating paint, furnishings, fashion, etc., are typically naïve. These tools allow a user to select a décor accessory and may even allow the user to narrow available décor accessories by one or more attributes (e.g., style, color). However, these tools lack the ability to find one or more harmonized (i.e., matching) décor accessories. Some tools offer the user an option to create and/or complete a set of décor accessories. However, these sets are either predetermined (i.e., a curator creates one or more defined sets) or created by the user. Those sets that are created by the user may not be harmonized because the user is unlikely to have experience with the aesthetic rules of harmony. Similarly, these tools lack the ability to search the Internet, a database, etc., for one or more harmonized décor accessories.

As described above, those décor accessories that are determined to match generally form a predefined set created by a curator. Various décor styles can also be expressed by multiple users in different ways. For example, “Green” can be used to describe a number of colors, and a “Minimal” or “Modern” style can have different meanings for different users. The current tools lack the ability to coordinate different ways of expressing a décor style to find harmonized décor accessories.

One constant challenge in designing a set of harmonized décor accessories is accurately implementing the rules of harmony. The rules of harmony, unlike many traditional rule sets, are very difficult to codify and, thus, are not easily implemented into a computer readable medium. Moreover, the rules of harmony are rarely applied in a consistent manner to a set of décor accessories. For example, décor accessories having various shades of “Green” may complement one another in some sets, but not complement one another in other sets.

Another challenge associated with designing a set of harmonized décor accessories is the lack of customization available to the user. Traditionally, a set of décor accessories are offered to the user as being part of a predetermined set. Any customization (e.g., replacing one or more members of the set) was done by the user and risked disrupting those properties (e.g., color, style) of the décor accessories that caused the various members of the predetermined set to match.

Generating a harmonized set of décor accessories can be difficult for a number of reasons. For example, the rules of aesthetic harmony are difficult to codify using conventional techniques. Difficulties can also arise when a user (e.g., consumer, buyer) wants to replace one or more décor accessories that form a harmonized set of décor accessories. Conventional harmonizing schemes are unable to replace a first member of a harmonized set of décor accessories with a new, distinct second member while maintaining the harmonizing aspects.

### BRIEF DESCRIPTION OF THE DRAWINGS

These and other objects, features and characteristics will become more apparent to those skilled in the art from a study of the following Detailed Description in conjunction with the appended claims and drawings, all of which form a part of this specification. In the drawings:

FIG. 1 is a block diagram illustrating an example method employed by a system for harmonizing a décor scheme in accordance with various embodiments;

FIG. 2 is a flow chart including a set of operations for creating a harmonized set of décor accessories in accordance with various embodiments;

FIG. 3A is an example of a harmony descriptor according to various embodiments;

FIG. 3B is another example of a harmony descriptor according to various embodiments;

FIG. 4A is another example a harmony descriptor according to various embodiments;

FIG. 4B is another example of a harmony descriptor according to various embodiments;

FIG. 5 is an example of a graphical user interface and a set of matching décor accessories according to various embodiments;

FIG. 6 is an example of a graphical user interface and a set of matching décor accessories according to various embodiments;

FIG. 7 is a pictorial illustration of the matches formed between décor accessories and their corresponding harmony descriptors in accordance with various embodiments;

FIG. 8 is a block diagram with exemplary components of a system for generating a set of harmonized décor accessories in accordance with various embodiments;

FIG. 9 is a spider diagram including a first and second set of matching décor accessories that are generated in accordance with various embodiments;

FIG. 10 is another spider diagram including a first and second set of matching décor accessories that is generated in accordance with various embodiments;

FIG. 11 is an example of a user interacting with a second set of matching décor accessories displayed on a graphical user interface;

FIG. 12 is a block diagram illustrating a method for generating a harmonized décor scheme in accordance with various embodiments;

FIG. 13 is a flow diagram of a process for creating a harmonized set of décor accessories in accordance with various embodiments;

FIG. 14 is a flow diagram illustrating an example process of harmonizing a décor accessory scheme, consistent with various embodiments;

FIG. 15A is a flow diagram illustrating a process for harmonizing a décor accessory scheme according to various embodiments;

FIG. 15B is a continuation of the flow diagram of FIG. 14A, which illustrates a process for harmonizing a décor accessory scheme according to various embodiments; and

FIG. 16 is a block diagram illustrating an example of a computer system in which at least some operations described herein can be implemented, consistent with various embodiments.

The figures depict various embodiments of this disclosure for purposes of illustration only. One skilled in the art will readily recognize from the following discussion that alternative embodiments of the structures and methods illustrated herein may be employed without departing from the principles of the invention described herein.

### DETAILED DESCRIPTION

Various embodiments of the disclosed technology generally relate to harmonizing décor schemes. More specifically, some embodiments relate to systems and methods for generating one or more harmony descriptors and a harmonized set of décor accessories using the one or more harmony descriptors. The system and method embodiments described herein enable a user to generate a harmonized set of décor accessories from a plurality of décor accessories.

In various embodiments, a representation of a plurality of décor accessories is provided. The plurality of décor accessories may include art, furniture, etc. Each representation of a single décor accessories can include metadata, which describes various properties of the décor accessory. For example, the metadata may include elements that describe the color, theme, accent, mood, style, etc., of the décor accessory.

In various embodiments, a system enables one or more harmony descriptors to be created from the metadata elements of the décor accessories. The harmony descriptors can identify matching décor accessories based on a subset of metadata elements of the décor accessories. Two or more metadata elements can be determined to be matching in many ways. In some embodiments, the subset of metadata elements match by being similar or identical. In some embodiments, the subset of metadata elements match by being complementary. For example, metadata elements can match if they include the same color (e.g., Ocean Rain) or if the metadata elements include colors that complement one another (e.g., Ocean Rain, Sand). The term “complement,” as it is used herein, refers to elements that are harmonized (i.e., match as part of a design scheme); it does not refer to the traditional concept of complementary colors (i.e., those pairs of colors that, when combined, cancel each other out).

In some embodiments, a system automatically determines whether the metadata elements of two décor accessories match. In some embodiments, a curator determines whether two décor accessories match. The curator can make this determination using one or more metadata elements or without reference to any pre-existing metadata. In some embodiments, the curator may create one or more metadata elements based on visual observations, trends, expert knowledge, etc., and match two décor accessories based on the created metadata elements. For example, the curator may determine that a first décor accessory and a second décor accessory should both be classified as “Urban,” and then match the two décor accessories together. Those harmony descriptors that are generated from the metadata elements can be stored in a harmony descriptor database.

In various embodiments, a system allows a user to select a décor accessory. Upon selection, the system can search the harmony descriptor database for one or more matching décor accessories. A décor accessory is determined to be matching if it shares a harmony descriptor with the selected décor accessory. In some embodiments, the system will return a set of décor accessories that match the selected décor accessory. The system may allow the user to continue searching the harmony descriptor database when a member of the set of matching décor accessories is selected. For example, if the user selects one member of the set of matching décor accessories, the system can search the harmony descriptor database for one or more décor accessories that match the selected member. If more than one matching décor accessory is found, a second set of matching décor accessories is created. In some embodiments, each member of the second set of matching décor accessories matches the original selected décor accessory.

In various embodiments, a system allows a curator to form matches between the plurality of décor accessories. The system can include a harmony descriptor database that includes one or more harmony descriptors created from the metadata elements of the décor accessories. The system may allow the curator to select a décor accessory. In some embodiments, the system proposes a suggested décor accessory as matching the selected décor accessory. The suggested décor accessory may be determined by a décor rules engine that implements a plurality of décor rules. For example, the décor rules engine may consider the harmony descriptor(s) of the selected décor accessory, the harmony descriptor(s) of the suggested décor accessories, individual metadata elements of the selected décor accessory and/or the suggested décor accessory, etc. The curator can confirm or reject the suggested décor accessory as matching the selected décor accessory. In some embodiments, the harmony descriptors of the selected décor accessory and the suggested décor accessory are updated based on the curator's response.

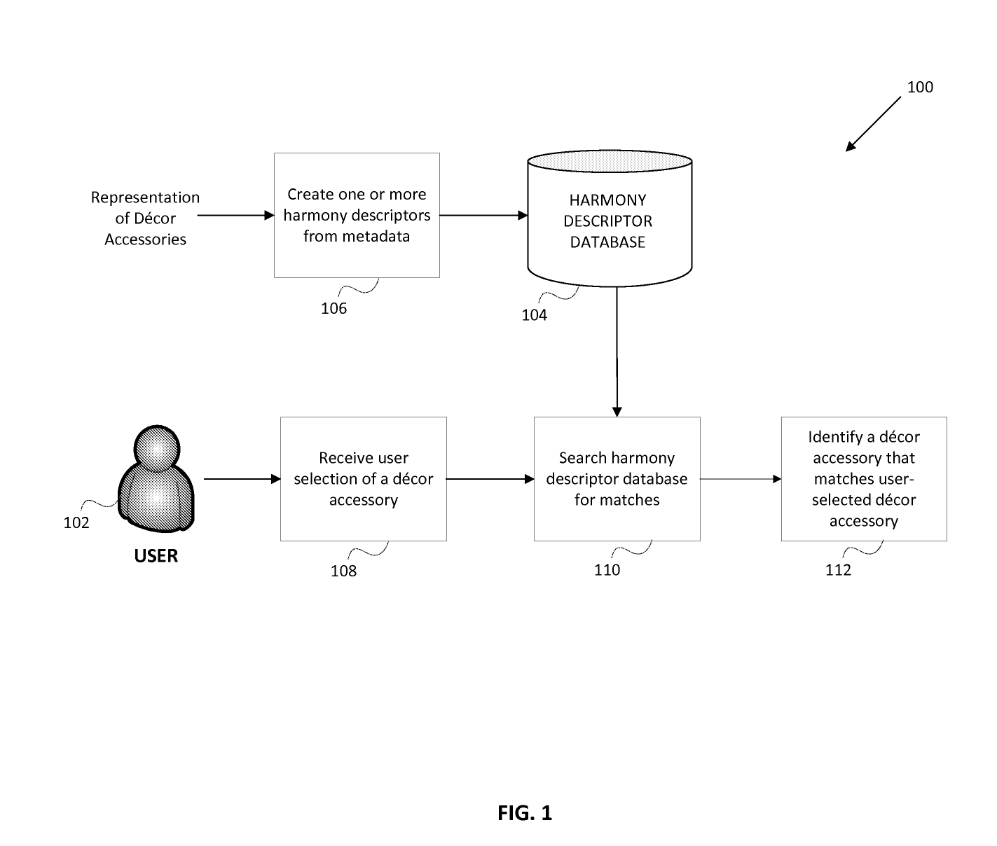

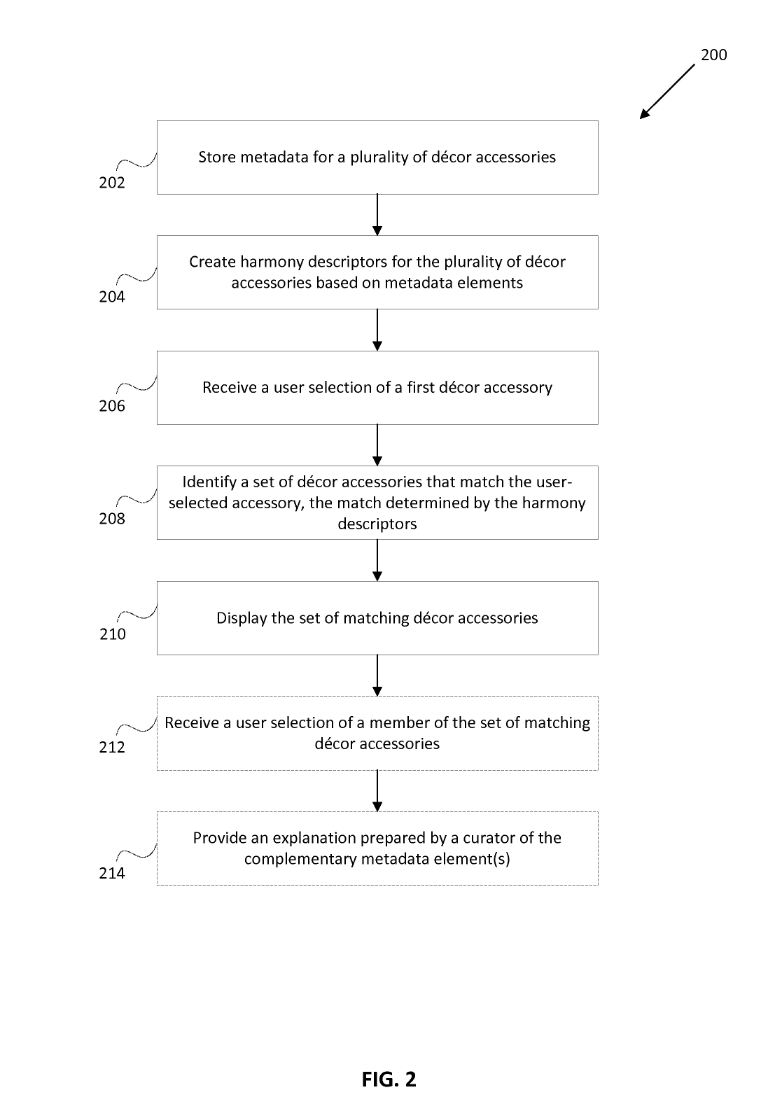

FIG. 1 is a block diagram illustrating an example method 100 employed by a system for harmonizing a décor scheme. In various embodiments, the system can receive a representation of a plurality of décor accessories. The plurality of décor accessories may be a complete set of décor accessories or a subset of décor accessories chosen from a larger set. The system can create one or more harmony descriptors from metadata corresponding to the plurality of décor accessories 106. Each harmony descriptor includes a subset of metadata elements belonging to one or more of the plurality of décor accessories. Accordingly, each harmony descriptor can identify one or more matches between at least two of the plurality of décor accessories. In various embodiments, the one or more harmony descriptors are stored in harmony descriptor database 104. Details with respect to creation of harmony descriptors are described at least with respect to FIGS. 2, 3A, 3B, 4A, 4B, 13, and 14.

In some embodiments, a user 102 may want to view one or more décor accessories that match (i.e., are in harmony with) a selected décor accessory. The system can receive a selection of a décor accessory 108 and search the harmony descriptor database 104 for one or more décor accessories 110 that match the selected décor accessory. The match can be determined based on a harmony descriptor of the selected décor accessory that is stored in the harmony descriptor database 104. The harmony descriptor can identify matching décor accessories based on one or more metadata elements belonging to the selected décor accessory.

The system can identify one or more matching décor accessories that match the selected décor accessory 112. The matches can be determined by the system based on one or more harmony descriptors of the selected décor accessory. The selected décor accessory and the one or more matching décor accessories identified by the system form a harmonized set.

Depending on the settings of the system, the curator- and user-characterizations of matching décor accessories can coexist (i.e., system utilizes both determinations) or be mutually exclusive (i.e., system utilizes one characterization or the other). For example, the system can be configured such that any characterizations made by a user may only be usable by said user. When a second user uses the system, any characterizations made by the first user may not affect those matches identified by the system.

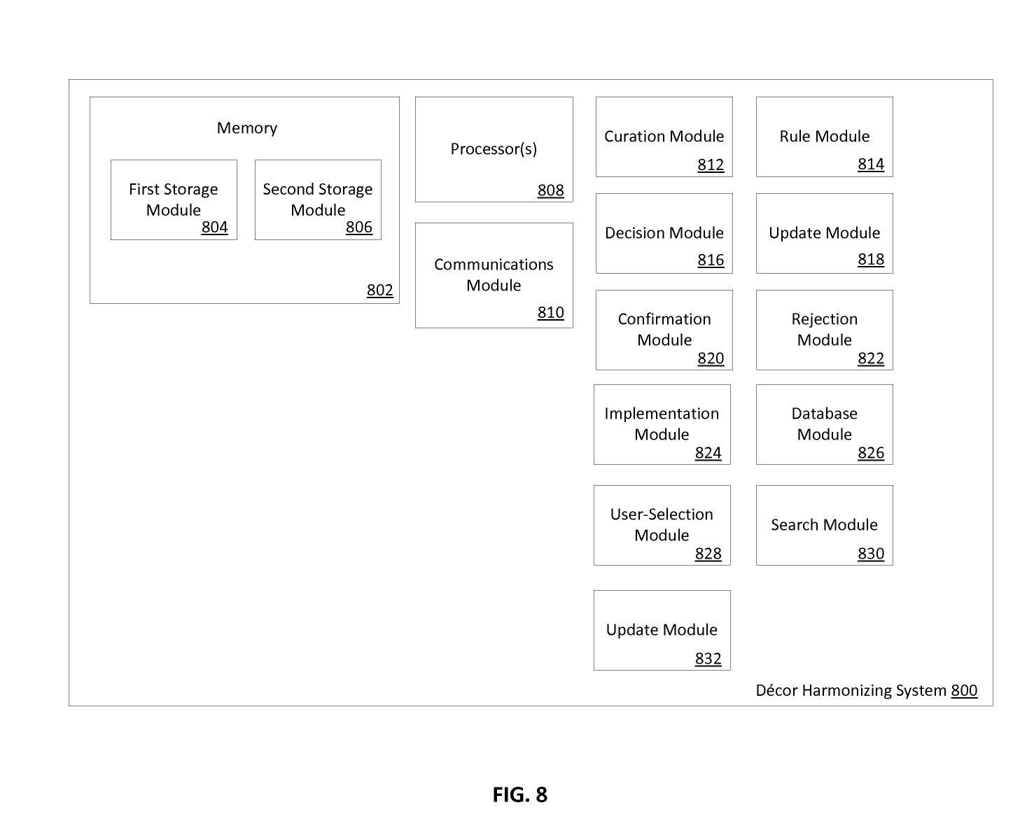

FIG. 2 is a flow chart of a process 200 for creating a harmonized set of décor accessories. At block 202, a system (e.g., décor harmonizing system 800 of FIG. 8) can store metadata for a plurality of décor accessories. The plurality of décor accessories can be a complete set of décor accessories or a subset of décor accessories chosen from a larger set. In some embodiments, the metadata includes one or more metadata elements that describe one or more of color, accent, visualness, mood, style, theme, etc. For example, a first metadata element can describe the style (e.g., Romantic, Abstract) of a décor accessory, while a second metadata element can describe the color (e.g., Green, Blue) of the same décor accessory.

At block 204, the system can create one or more harmony descriptors for the plurality of décor accessories based on one or more metadata elements. In various embodiments, each harmony descriptor includes a subset of metadata elements belonging to a plurality of décor accessories. Accordingly, each harmony descriptor can identify one or more matches between at least two of the plurality of décor accessories. For example, a first harmony descriptor can identify matching metadata elements of a first décor accessory and a second décor accessory, while a second harmony descriptor can identify matching metadata elements of the second décor accessory and a third décor accessory. In various embodiments, the harmony descriptors are used to identify one or more matches between the plurality of décor accessories. In some embodiments, the match is based on similar or identical metadata elements shared by two décor accessories, while in other embodiments the match is based on complementary metadata elements of the two décor accessories. For example, metadata elements can match if they include the same color (e.g., Ocean Rain), if they include similar colors (e.g., Ocean Rain, Emerald Spray), or if the metadata elements include colors that complement one another (e.g., Ocean Rain, Sand). As another example, metadata elements can match if they include the style (e.g., Modern) or if the metadata elements include styles that complement one another (e.g., Modern, Contemporary).

At block 206, the system can receive a user selection of a selected décor accessory. At block 208, the system can identify a set of matching décor accessories that match the selected décor accessory in response to the user selection. In various embodiments, the match is determined by the one or more harmony descriptors of the user-selected décor accessory. As described above, the one or more harmony descriptors identify matching metadata elements of the user-selected décor accessory and the plurality of décor accessories. In some embodiments, the metadata elements match by being similar or identical. In some embodiments, the metadata elements match by being complementary. At block 210, the system can generate the set of matching décor accessories. Generating may include creating a list of matching décor accessories, displaying the list of matching décor accessories on a graphical user interface, etc. In some embodiments, the set of matching décor accessories is displayed to the user as the set is intended to be implemented. For example, the set of matching décor accessories may be arranged in a living room, kitchen, bedroom, etc.

At block 212, the system can receive a user selection of a member of the set of matching décor accessories. At block 214, the system can provide an explanation of the one or more metadata elements that caused the match between the selected décor accessory and the selected member of the set of matching décor accessories. In various embodiments, blocks 212 and 214 are optional and may not be implemented. In some embodiments, the explanation is input by a curator, who may also create metadata elements and/or a predetermined set of matching décor accessories. In various embodiments, the explanation can be input by a user, or the system can generate one or more recognized explanations based on more than one explanation input by more than one user. The explanation can describe the one or more metadata elements that caused the décor accessories to match. For example, if the matching metadata elements are complementary, the curator may elect to provide an explanation (e.g., “ . . . the color ocean blue matches the color sand because . . . ”). The curator may elect to provide a concise explanation, or refrain from drafting an explanation at all, if the metadata elements are identical (e.g., both décor accessories include the color ocean blue).

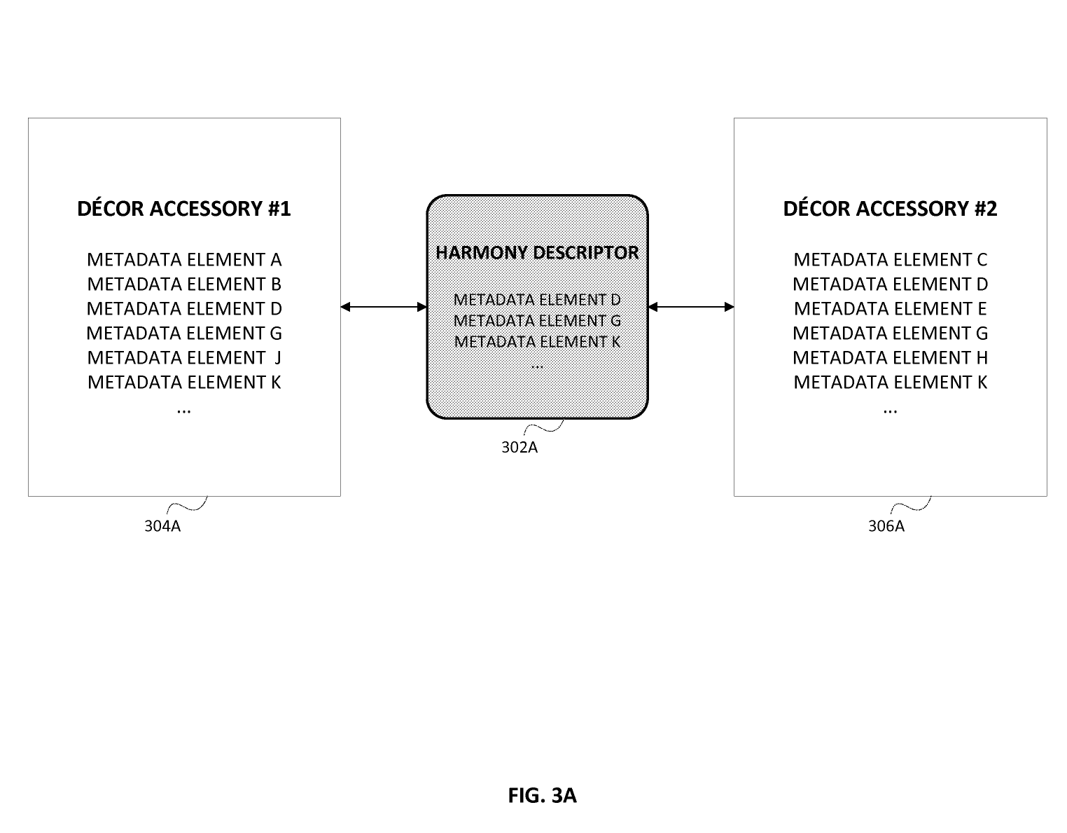

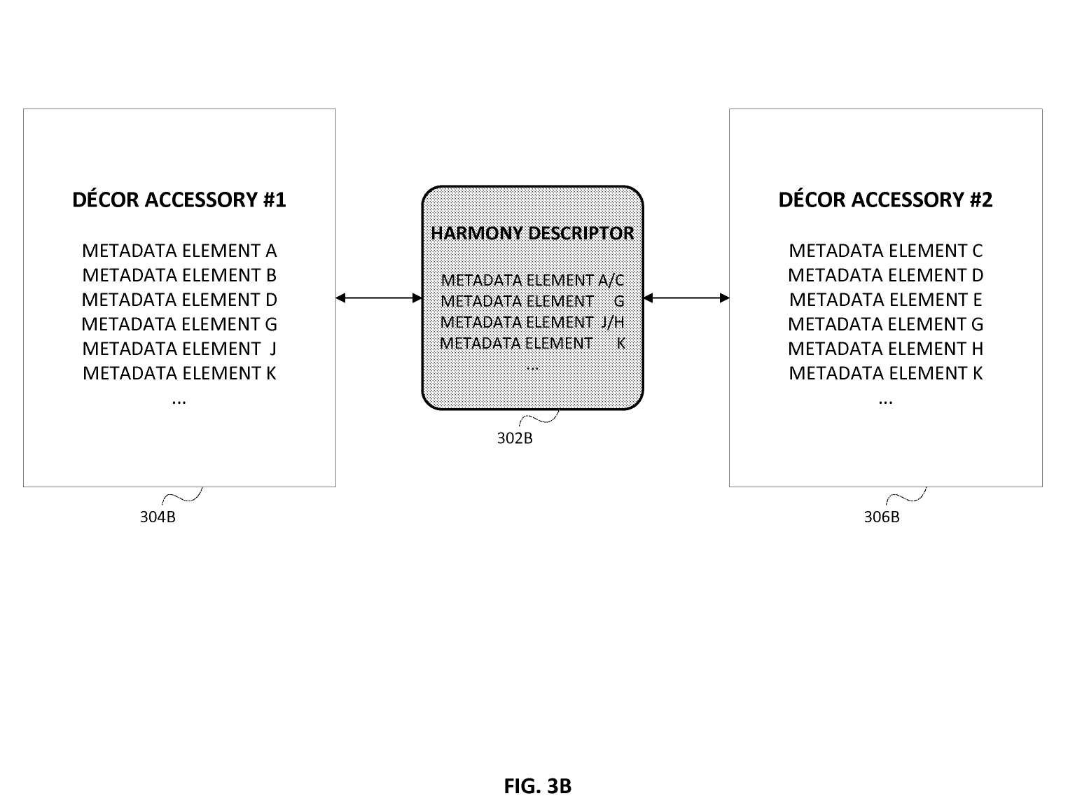

FIG. 3A and FIG. 3B are examples of harmony descriptors according to various embodiments. Harmony descriptor 302A, 302B can include one or more metadata elements that describe color, accent, visualness, mood, style, theme, etc., of a pair of décor accessories that match, (e.g., first décor accessory 304A, 304B and second décor accessory 306A, 306B). The metadata elements can be generated automatically by a computer-implemented system (e.g., system 800), manually by a creator (e.g., curator), or a combination thereof. For example, a computer-implemented system may automatically generate a plurality of metadata elements for a décor accessory that are used to create one or more harmony descriptors. As another example, a curator may create additional metadata elements and/or delete, modify, etc., one or more existing metadata elements created automatically by the computer-implemented system. In various embodiments, the harmony descriptors generated by the computer-implemented system can include metadata elements automatically generated by the system and metadata elements manually created by a curator.

In some embodiments, a harmony descriptor 302A identifies one or more décor accessories as matching a specified décor accessory based on metadata. For example, harmony descriptor 302A identifies a second décor accessory 306A as matching a first décor accessory 304A. In some embodiments, the match can be based on similar or identical metadata elements shared by the first décor accessory 304A and the second décor accessory 306A. For example, a first shared metadata element (e.g., metadata element D) may correspond to “Mood : Calm,” a second shared metadata element (e.g., metadata element G) may correspond to “Color : Ocean Mist,” etc.

In some embodiments, the match can be based on complementary metadata elements belonging to a first décor accessory 304B and a second décor accessory 306B. For example, a first metadata element (e.g., metadata element A) belonging to the first décor accessory 304B may correspond to “Color: Ocean Mist,” and a second metadata element (e.g., metadata element C) belonging to the second décor accessory 306B may correspond to “Color: Ocean Rain.” Although the metadata elements of the first décor accessory 304B and the second décor accessory 306B are not identical, a computer-implemented system (e.g., system 800) or a curator may determine that the metadata elements match (e.g., both have a nautical theme, colors complement one another). While specific examples of mood and color are described herein, one skilled in the art will recognize that the harmony descriptors 302A, 302B could identify matches based on accent, visualness, style, theme, tags, etc.

The computer-implemented system can determine that metadata elements match based on a plurality of décor harmony rules implemented by a décor rules engine. The décor harmony rules may generate matches based on RGB or hex triplet value, saturation level, hue level, color pixel density, hue-saturation-lightness (HSL) coordinate, hue-saturation-value (HSV) coordinate, etc. For example, the décor rules engine may determine that a first décor accessory (22% red color pixels) matches a second décor accessory (15% red color pixels) because both décor accessories have a strong red accent. One skilled in the art will recognize that many décor harmony rules could be implemented that take into account various characteristics of the décor accessories.

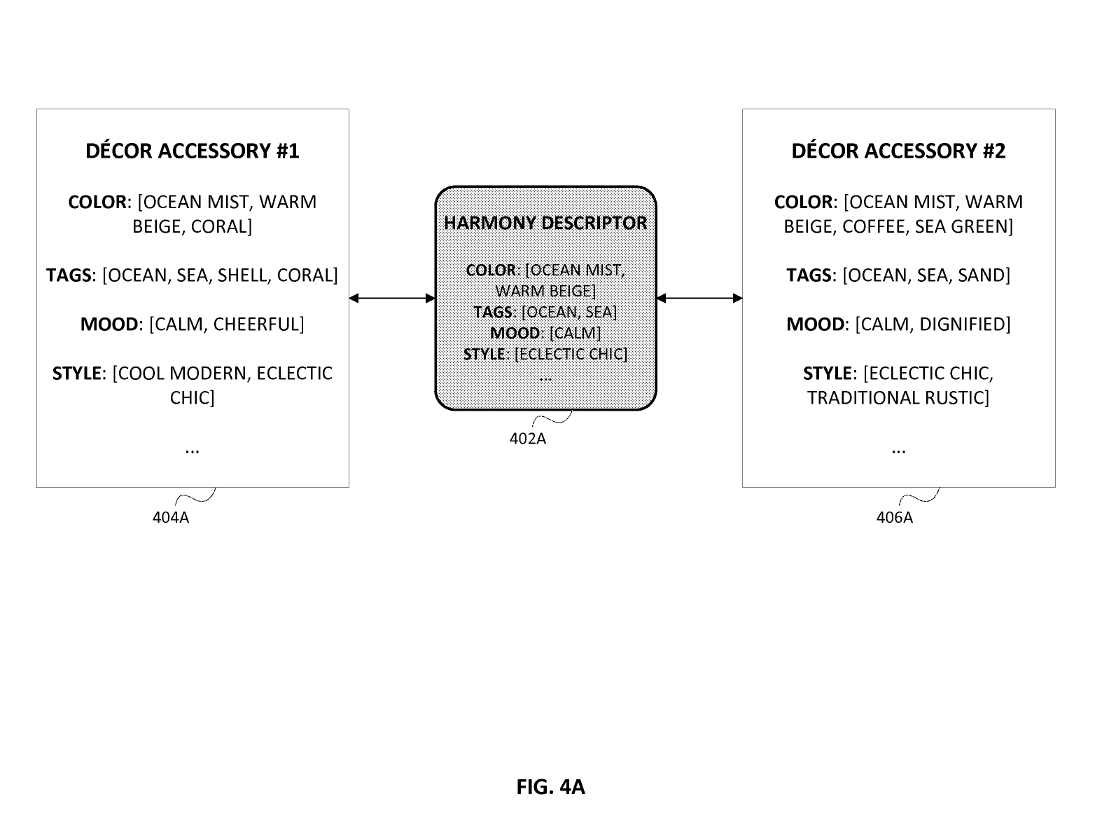

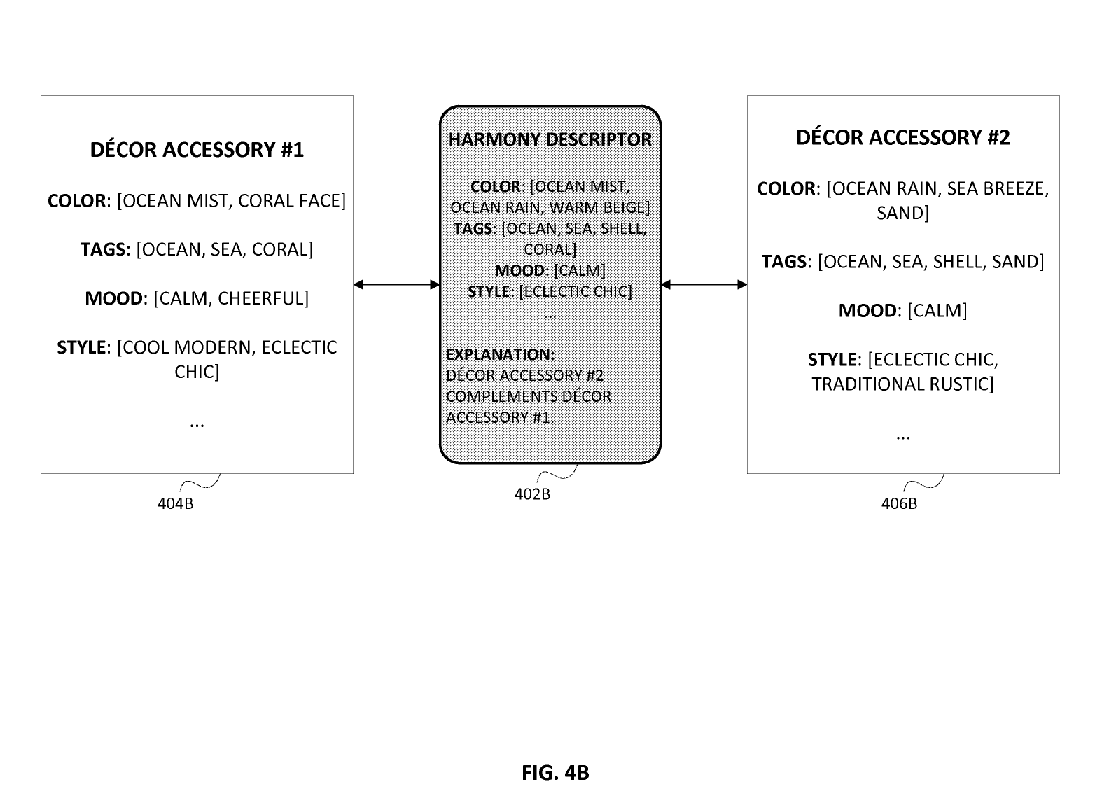

FIG. 4A and FIG. 4B are additional examples of harmony descriptors according to various embodiments. Harmony descriptor 402A, 402B can include one or more metadata elements that describe color, accent, visualness, mood, style, theme, etc. The metadata elements can correspond to one or more artistic, aesthetic, etc., properties of the matching décor accessories. For example, FIG. 4A illustrates a harmony descriptor 402A that includes at least four metadata elements that caused a match between a first décor accessory 404A and a second décor accessory 406A. The metadata elements may be, for example, shared colors (e.g., ocean mist, warm beige), moods (e.g., calm), styles (e.g., eclectic chic), tags (e.g., ocean, sea), etc. A tag can be created automatically by a computer-implemented system (e.g., décor harmonizing system 800), manually by a creator (e.g., curator, user), or a combination thereof. In some embodiments, the tags may be used to indicate that one or more décor accessories (e.g., first décor accessory 404A or second décor accessory 406A) are members of a predetermined set. For example, a plurality of décor accessories may include a particular tag (e.g., Nautical Set #1) to indicate that those décor accessories can be grouped together to form a particular set.

In some embodiments, the match can be based on complementary metadata elements belonging to a first décor accessory 404B and a second décor accessory 406B. For example, the harmony descriptor 402B may include one or more colors (e.g., ocean mist, ocean rain), tags (e.g., coral, shell), etc., determined to be complementary. In some embodiments, the harmony descriptor 402B may be configured to incorporate colors determined to be complementary of those found in the first décor accessory 404B and the second décor accessory 406B. For example, the color element of harmony descriptor 402B includes present complementary colors (i.e., ocean mist, ocean rain) and an absent complementary color (i.e., warm beige). Although warm beige does not appear in either the first décor accessory 404B or the second décor accessory 406B, warm beige may be included in the harmony descriptor 402B as being complementary. The matches can also be based on metadata of more than one type (i.e., complementary metadata elements do not need to be the same type of metadata). For example, a metadata element for color (e.g., Ocean Mist) may match a metadata element for style (e.g., Nautical), mood (e.g., Calm), etc.

In some embodiments, the harmony descriptor 402B can include an explanation. The explanation can be input by a user (e.g., a curator), generated by a computer-implemented system (e.g., décor harmonizing system 800), or a combination thereof. The explanation, which can be shown to a user, can be particularly useful for describing an aesthetic/décor relationship when the harmony descriptor matches a first décor accessory 404B and a second décor accessory 406B based on complementary, and potentially disparate (e.g., color and style), metadata elements. For example, harmony descriptor 402B may include an explanation that states, “The ocean mist color of décor accessory #1 complements the ocean rain color of décor accessory #2.” Similarly, harmony descriptor 402B can include an explanation that states, “Décor accessory #1 and décor accessory #2 are both tagged as ‘ocean’ accessories.” One skilled in the art will recognize that the explanation can be incorporated into the harmony descriptor 402B at various points in time. In some embodiments, the explanation is input by a user or the computer-implemented system while sets of matching décor accessories are created. In some embodiments, the explanation is input by the curator, a user, etc., after a set of matching décor accessories has been recommended.

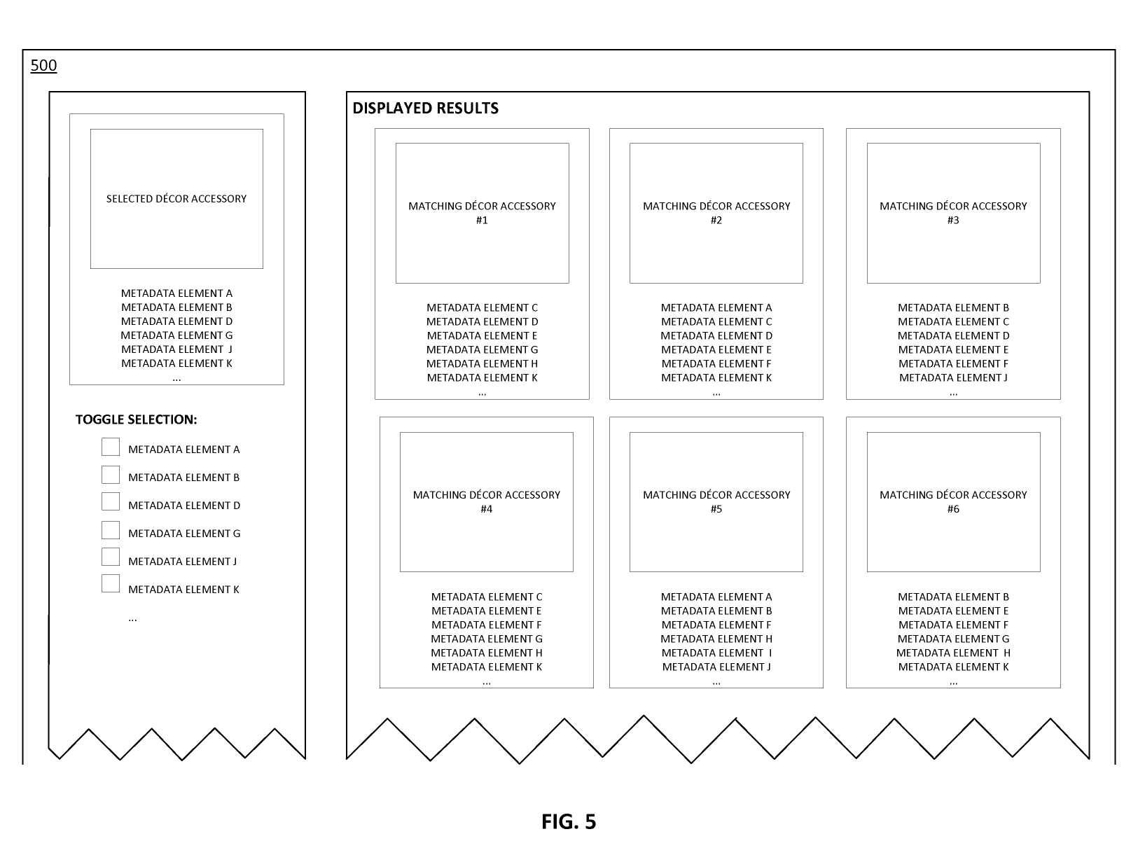

FIG. 5 is an example of a graphical user interface (GUI) 500 and a set of matching décor accessories. In various embodiments, a décor harmonizing system (e.g., décor harmonizing system 800) can be configured to receive a user selection of a selected décor accessory, search a harmony descriptor database for matching décor accessories, and generate a first set of matching décor accessories. In some embodiments, the first set of matching décor accessories can be displayed on the GUI 500 in tabular format. For example, GUI 500 illustrates a set of matching décor accessories arranged in rows and columns. In some embodiments, the matching décor accessories can be arranged alphabetically, by popularity, by the number of matching metadata elements, by similarity score, etc. A similarity score may be calculated that determines the degree to which two décor accessories match based on matching metadata (i.e., the harmony descriptor). A higher similarity score may indicate the two décor accessories have more matching metadata elements.

In various embodiments, the graphical user interface 500 allows a user to modify the displayed results. The user can toggle one or more selections to determine whether a subset of the matching décor accessories is shown. For example, the user may elect to only show matching décor accessories that include metadata element A, metadata element B, metadata elements A and B, etc. More specifically, the user may elect to only show matching décor accessories that include a particular color (e.g., ocean blue), a particular style (e.g., modern), a particular color and style (e.g., ocean blue and modern), etc. The selections available for the user to toggle can include all matching metadata elements (i.e., similar, identical, and complementary) and explanations. For example, the user may choose to search for one or more rules (e.g., clashing combination, whimsical pairing) that only exist in the explanation. In some embodiments, the graphical user interface 500 allows the user to modify how results are displayed. For example, the matching décor accessories may be arranged by popularity, cost, type (e.g., artwork, furniture), etc.

In some embodiments, the GUI 500 allows the user to easily retain and/or discard matching décor accessories. For example, if the user elects to retain a first matching décor accessory, the tabular entry may be highlighted in some way (e.g., green border, increased brightness). In some embodiments, the first matching décor accessory may be removed from the “Displayed Results” and stored elsewhere (e.g., side window panel, shopping cart) when the user elects to retain the first matching décor accessory. The user may elect to retain the first matching décor accessory by, for example, double-clicking, swiping to the left, etc. If the user elects to discard a second matching décor accessory, the tabular entry may be highlighted in some way (e.g., red border, muted coloration). In some embodiments, the second matching décor accessory may be removed from the “Displayed Results” when the user elects to discard the second matching décor accessory. The user may discard the second matching décor accessory in various ways. For example, the user may right-click, swipe to the right, etc.

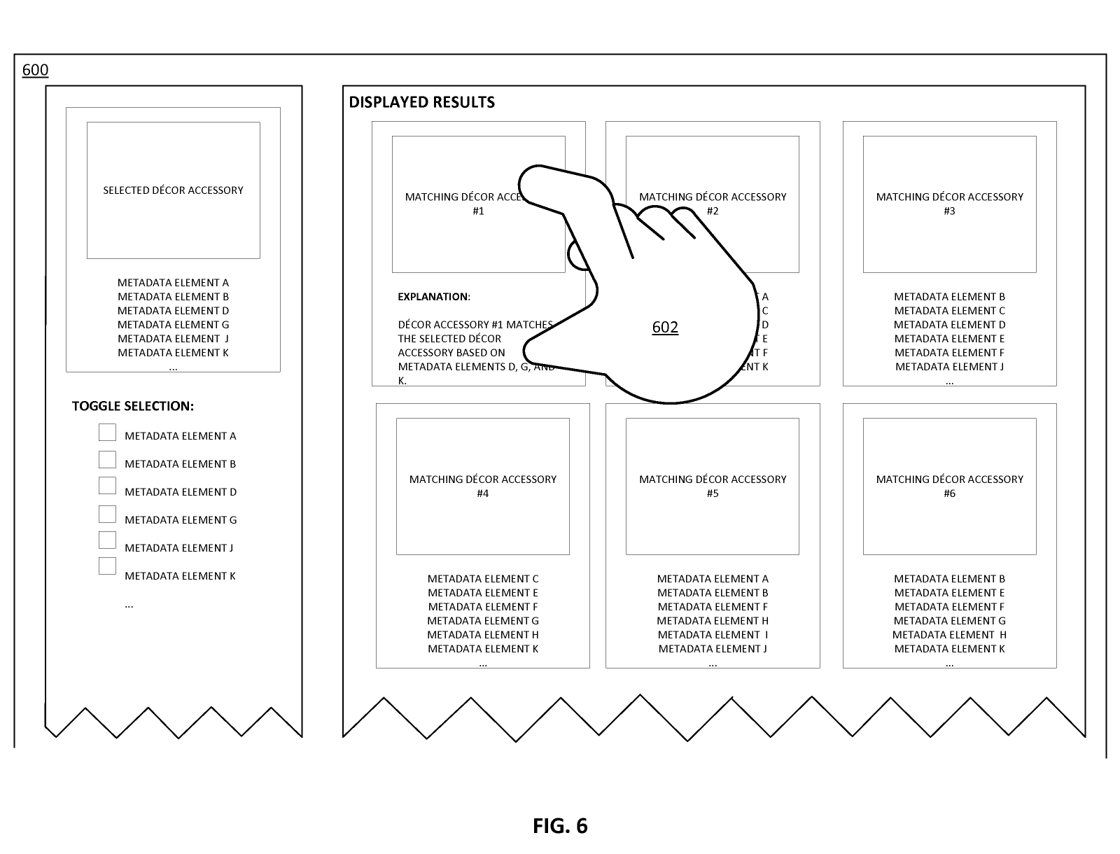

FIG. 6 is an example of a graphical user interface 600 and a set of matching décor accessories. In various embodiments, a décor harmonizing system (e.g., décor harmonizing system 800) may be implemented using a GUI 600 that is configured to receive a user selection of a selected décor accessory, search a harmony descriptor database for décor accessories that match the selected décor accessory, and generate a first set of matching décor accessories. In some embodiments, the GUI 600 can be configured to interact with a user 602. For example, the user 602 may interact with the GUI 600 through the use of a touchscreen, vocal commands, pointing device, etc. In some embodiments, the GUI 600 can be configured to modify its appearance based on one or more user inputs.

For example, when the user 602 selects a matching décor accessory, the GUI 600 may be configured to display an explanation. The explanation can describe the one or more metadata elements that cause a matching décor accessory to match the selected décor accessory. For example, if the matching metadata elements are identical, the explanation may say, “Décor accessory #1 matches the selected décor accessory based on shared metadata elements D, G, and K.” If the matching metadata elements are complementary, the explanation may say, “Décor accessory #1 matches the selected décor accessory based on complementary metadata elements A and C.” While a limited number of examples have been included herein for readability purposes, one skilled in the art will recognize that many different metadata element combinations and explanations are possible.

In some embodiments, the GUI 600 can be configured to recognize predetermined user inputs and/or implement new user inputs. For example, a matching décor accessory may be rejected if the user swipes the matching décor accessory to the right. As another example, the GUI 600 may zoom in on a particular matching décor accessory if the user clicks, taps, etc., on it twice.

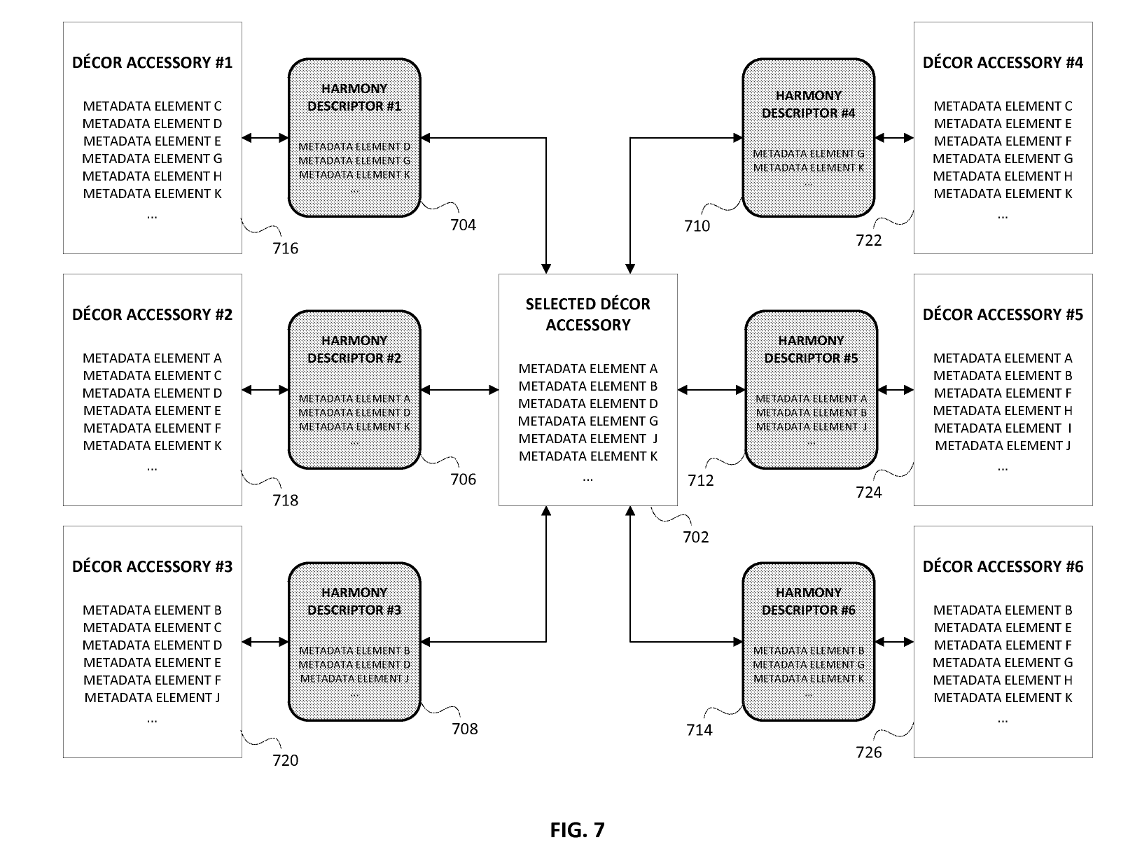

FIG. 7 is a pictorial illustration of the matches formed between décor accessories and their corresponding harmony descriptors. In various embodiments, a décor harmonizing system (e.g., décor harmonizing system 800) is configured to receive a representation of a plurality of décor accessories. The décor harmonizing system can create one or more harmony descriptors 704, 706, 708, 710, 712, 714 from metadata corresponding to a plurality of décor accessories 716, 718, 720, 722, 724, 726. The harmony descriptors, which can include a subset of metadata elements belonging to one or more of the plurality of décor accessories, identify matches between at least two of the plurality of décor accessories. The matches, as described above, can be based on identical or complementary metadata elements.

In various embodiments, the décor harmonizing system can be configured to receive a user selection of a selected décor accessory 702 from the plurality of décor accessories. The décor harmonizing system can perform a search to identify a set of décor accessories 716, 718, 720, 722, 724, 726 that match the selected décor accessory 702. The matches can be determined based on a single harmony descriptor or a plurality of harmony descriptors 704, 706, 78, 710, 712, 714 of the selected décor accessory 702. For example, a harmony descriptor (e.g., harmony descriptor 704) can identify one or more matching décor accessories. More specifically, the harmony descriptor can identify a first matching décor accessory, a first and second matching décor accessory, etc. The one or more harmony descriptors of the selected décor accessory represent one or more metadata elements that cause at least two décor accessories to match.

FIG. 8 is a block diagram with exemplary components of a system 800 for generating a set of harmonized décor accessories. According to the embodiment shown in FIG. 8, the décor harmonizing system 800 can include a memory 802 that includes a first storage module 804 and a second storage module 806, one or more processors 808, a communications module 810, a curation module 812, a rule module 814, a decision module 816, an update module 818, a confirmation module 820, a rejection module 822, an implementation module 824, a database module 826, a user-selection module 828, and a search module 830. Other embodiments of décor harmonizing system 800 may include some, all, or none of these modules and components along with other modules, applications, and/or components. Still yet, some embodiments may incorporate two or more of these modules into a single module and/or associate a portion of the functionality of one or more of these modules with a different module.

Memory 802 can be any device or mechanism used for storing information. Memory 802 may be used to store instructions for running one or more applications or modules (e.g., curation module 812, rule module 814) on processor(s) 808. For example, memory 802 could be used in some embodiments to house all or some of the instructions needed to execute the functionality of the communications module 810, the curation module 812, the rule module 814, the decision module 816, the update module 818, the confirmation module 820, the rejection module 822, the implementation module 824, the database module 826, the user-selection module 828, and/or the search module 830.

Communications module 810 may manage communications between components and/or other systems. For example, the communications module 810 may be used to send information (e.g., harmony descriptors) collected by the décor harmonizing system 800 to another system, device, storage, etc., on a schedule (e.g., periodic, on-demand, user-specified, event-triggered). Communications module 810 may also receive a modification, update, etc., to be implemented on the décor harmonizing system 800. For example, communications module 810 may receive new décor accessories and representations thereof to be stored in the first storage module 804, new harmony descriptors to be stored in the second storage module, etc.

First storage module 804 can be configured to store representations of a plurality of décor accessories. In some embodiments, the representations include one or more metadata elements that describe various properties (e.g., color, style, mood) of each of the plurality of décor accessories. Second storage module 806 can be configured to store one or more harmony descriptors. Details with respect to the harmony descriptors are described at least with respect to FIGS. 1, 3A, 3B, 4A, 4B, and 7. In some embodiments, first storage module 804 and second storage module 806 are combined into a single storage module.

Curation module 812 can allow a creator (e.g., a curator) to choose a selected décor accessory from the plurality of décor accessories stored in first storage module 804. Rule module 814 can propose a suggested décor accessory to match the selected décor accessory. In some embodiments, the rule module 814 selects the suggested décor accessory based on a plurality of décor rules implemented by the décor harmonizing system 800. The décor harmonizing system 800 can, for example, implement a décor rules engine (e.g., décor rules engine 1024). Details with respect to the décor rules are described above at least with respect to FIG. 3B. In various embodiments, the décor rules include a harmony descriptor that identifies the suggested décor accessory as matching the selected décor accessory. The harmony descriptor can include one or more metadata elements of the selected décor accessory and the suggested décor accessory that caused the décor rules to determine a match was formed. In various embodiments, the metadata elements and/or explanations are searchable. As described above, searchable metadata elements can describe color, accent, visualness, mood, style, theme, tags, etc. In some embodiments, a searchable metadata element that includes a curator's name, a curator's unique identifier, etc., can be used by a user to search for matches generated by a particular curator. For example, the user may elect to search for matches generated by a particular curator because the user appreciates the style, taste, etc., of the particular curator. Searchable explanations can include one or more rules, keywords, etc., that cause the curator to confirm the suggested décor accessory as matching the selected décor accessory.

A decision module 816 can allow the creator (e.g., curator) to confirm or reject the suggested décor accessory as matching the selected décor accessory. An update module 818 can update the harmony descriptors stored in the second storage module 806 based on a response received from the creator (i.e., confirmation or rejection).

A confirmation module 820 can allow the creator to input an explanation if the creator confirmed the suggested décor accessory as matching the selected décor accessory. The explanation can describe the one or more metadata elements that cause the suggested décor accessory to match the selected décor accessory. The explanation can be stored in the harmony descriptor, thereby creating an updated harmony descriptor. The harmony descriptors and updated harmony descriptors may all be stored in second storage module 806. Similarly, a rejection module 822 can allow the creator to input an explanation if the creator rejected the suggested décor accessory as matching the selected décor accessory. In some embodiments, the creator may elect to input an explanation that describes why the suggested décor accessory does not match the selected décor accessory. For example, the creator may determine that, although the selected décor accessory and suggested décor accessory both have a matching accent color (e.g., red), the selected décor accessory and the suggested décor accessory have different moods (e.g., calm and lively) that cause the accessories to not match.

An implementation module 824 can ensure that, if a user chooses the selected décor accessory in the future, the suggested décor accessory is proposed as a match if the creator confirmed the match. Similarly, the implementation module 824 can ensure that the suggested décor accessory is not proposed as a match if the creator rejected the match.

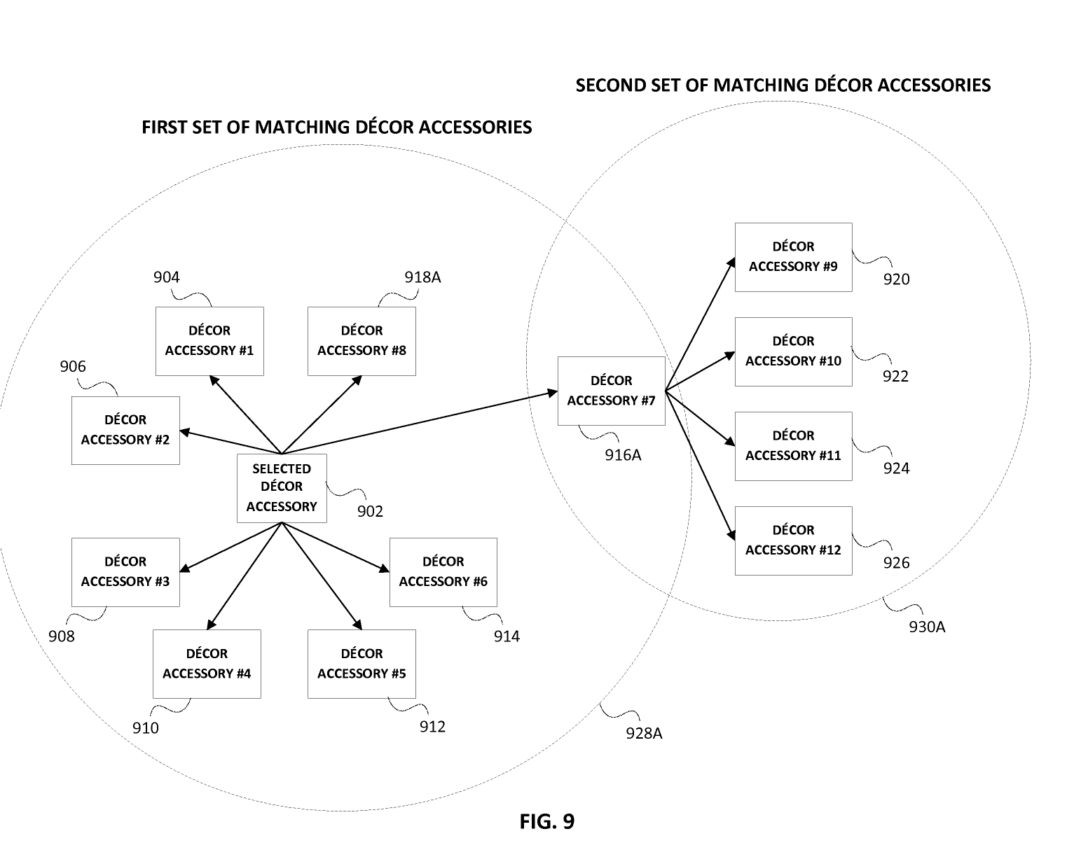

A database module 826 can create, maintain, update, etc., a graph database that includes a set of nodes. In various embodiments, each node has one or more properties and one or more edges. Each of the nodes can represent one of the plurality of décor accessories, each of the properties can represent a searchable metadata element, and each edge can represent a match based on one or more harmony descriptors. In various embodiments, a parent node links to at least one child node via a unique identifier or field. The child node may be bi-directional. In some embodiments, one or more of the edges are stateless or implied by the unique identifier or field. Each edge can include one or more metadata elements that describe the reason for the connection between two nodes. In various embodiments, the edge includes a metadata element that identifies the curator(s) who generated the match. The metadata element may be searchable, which allows the graph database to be traversed by another curator, a user, etc., according to the preferences (i.e., tastes) of the identified curator. In some embodiments, the edge also includes a metadata element or an explanation that is input by the identified curator that describes why two nodes (i.e., décor accessories) match. In various embodiments, some combination of the nodes, edges, curator metadata, explanation, etc., are searchable. Details with respect to the harmony descriptors are described at least with respect to FIGS. 9, 10, 11, 14, 15A, and 15B.

A user-selection module 828 can be configured to receive a user selection of a décor accessory from the plurality of décor accessories. The user-selected décor accessory may be chosen in many ways. For example, the user may choose the décor accessory using a GUI (e.g., GUI 500). A search module 830 can perform a search to identify one or more décor accessories that match the user-selected décor accessory. In various embodiments, the match is determined based on the harmony descriptors and updated harmony descriptors stored in second storage module 806. Because the search module 830 identifies at least one matching décor accessory, the at least one matching décor accessory and the user-selected décor accessory form a matching set of décor accessories. In some embodiments, an update module 832 can update the harmony descriptors based on information received by the décor harmonizing system 800. Relevant information may include, for example, a confirmation or rejection by a creator, newly formed metadata elements, modified metadata elements, etc. One skilled in the art will recognize that the update module 832, database module 826, and implementation module 824 can perform similar functions. Accordingly, these modules may be joined to form one or more combined modules that, collectively, update the harmony descriptors, ensure the updates take effect, etc.

FIG. 9 is a spider diagram including a first set 928A and a second set 930A of matching décor accessories that are generated in accordance with various embodiments. “Spider diagram,” as that term is used herein, refers to any visual representation of one or more relationships between ideas. More specifically, a spider diagram will generally illustrate the relationships between a central idea (e.g., selected décor accessory) and any related ideas (e.g., matching décor accessories). In some embodiments, the spider diagram can be implemented using a graph database. A décor harmonizing system (e.g., décor harmonizing system 800) can receive a representation of a plurality of décor accessories, create one or more harmony descriptors that describe matches formed between the plurality of décor accessories, and perform a search to identify a first set 928A of décor accessories that match a selected décor accessory 902 chosen by a user. In various embodiments the matches are determined based on one or more harmony descriptors of the selected décor accessory 902. The first set 928A of décor accessories may include one or more matching décor accessories 904, 906, 908, 910, 912, 914, 916, 918. The décor harmonizing system can be configured, or the user may elect, to only identify n-number of matching décor accessories, where “n” represents an integer value. For example, the user may specify seven matching décor accessories, which will result in a matching set (e.g., first set 928A) that includes eight members.

In some embodiments, the décor harmonizing system can be configured to receive a user selection of a member of the first set 929A of décor accessories. For example, FIG. 9 represents a user selection of décor accessory 916A. In some embodiments, an explanation can be provided to the user upon receiving the user selection. The explanation may describe one or more metadata elements that caused the selected member (e.g., décor accessory 916A) of the first set 928A of décor accessories to match the selected décor accessory 902. In some embodiments, the explanation is input by a user (e.g., curator).

The décor harmonizing system can retrieve, from a storage medium (e.g., memory 802), information regarding previous user selections of members of the first set of décor accessories 928A (décor accessories 904, 906, etc.). The décor harmonizing system may analyze the harmony descriptors of the selected décor accessory 902, one or more harmony descriptors of the plurality of décor accessories (904, 906, . . . , 924, 926) and the information regarding previous user selections in order to identify a first set 928A of matching décor accessories.

In various embodiments, the décor harmonizing system can further include a graph database that includes a set of nodes and one or more edges. Each node represents one of a plurality of décor accessories and can have one or more properties. The one or more properties represent one or more searchable metadata elements belonging to a décor accessory. An edge represents a match between two décor accessories based on a harmony descriptor. In various embodiments, the edge can represent one or more metadata element shared between two décor accessories. The graph database can be configured to be easily scalable, such that additional nodes, edges, and properties can be added, modified, and/or deleted without affecting the ability of the décor harmonizing system to generate one or more matching sets of décor accessories.

The décor harmonizing system can be configured to receive a user selection of a member (e.g., décor accessory 916A) of the first set 928A of décor accessories and perform a search to identify a second set 930A of décor accessories that match the member selected from the first set 928A of décor accessories. In some embodiments, the members of the sets can be represented to a user by a plurality of nodes and edges. The matches between the décor accessories can be based on one or more harmony descriptors belonging to the member selected (e.g., décor accessory 916A) from the first set 928A of décor accessories. In some embodiments, the second set 930A of décor accessories is represented by a plurality of nodes and the one or more harmony descriptors are represented by a plurality of edges connecting a first node (e.g., décor accessory 916A) to the plurality of nodes (e.g., décor accessories 920, 922, 924, 926).

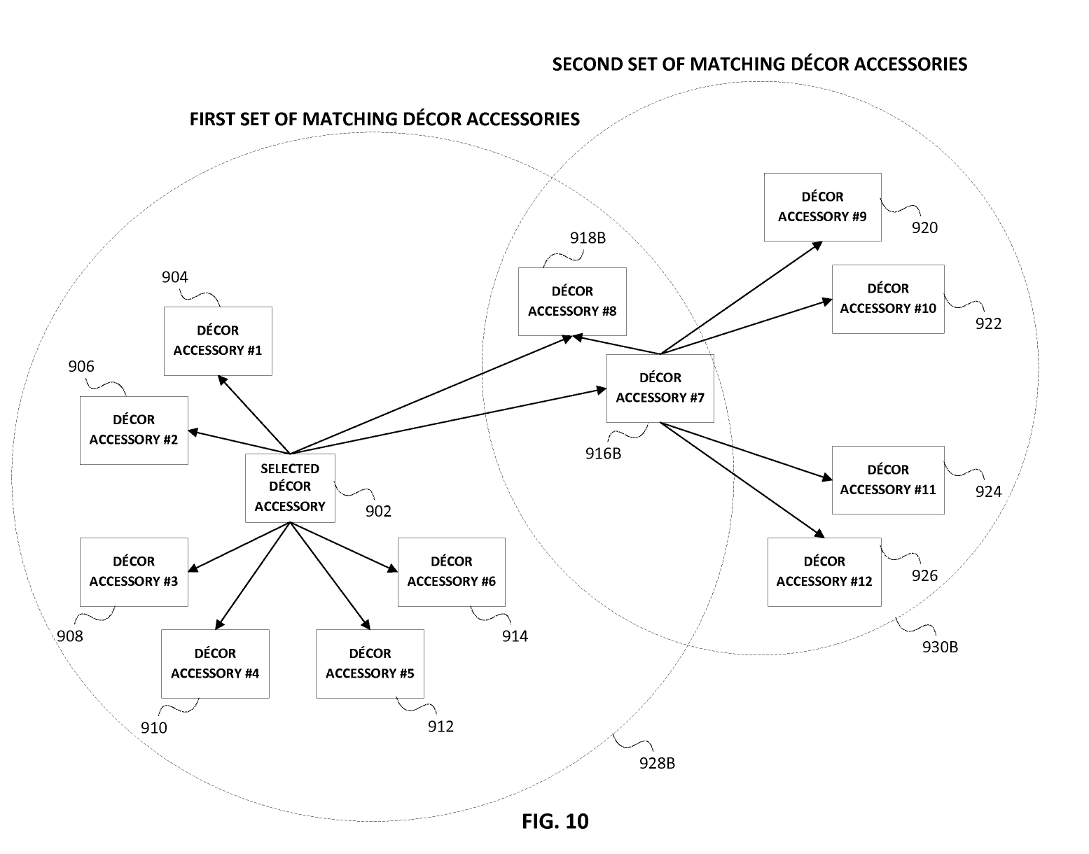

FIG. 10 is another spider diagram including a first set 928B and a second set 930B of matching décor accessories. More specifically, FIG. 9 represents overlapping between the first set 928B of matching décor accessories and the second set 930B of matching décor accessories. In some embodiments, there will be no overlap. For example, FIG. 9 represents a first scenario where the décor harmonizing system proposes a second set 930A of matching décor accessories that includes new (i.e., distinct) décor accessories 920, 922, 924, 926. That is, none of the newly recommended décor accessories 920, 922, 924, 926 were previously recommended to the user. Conversely, FIG. 10 represents a second scenario where the décor harmonizing system proposes a second set 930B of matching décor accessories that includes new (i.e., distinct) décor accessories 920, 922, 924, 926 and a previously recommended décor accessory 918B. More specifically, one of the proposed décor accessories (i.e., décor accessory 918B) was previously proposed as a match to selected décor accessory 902. One skilled in the art will recognize that none, some, or all of the members of the second set 930B of match décor accessories may overlap with the first set 928B of matching décor accessories.

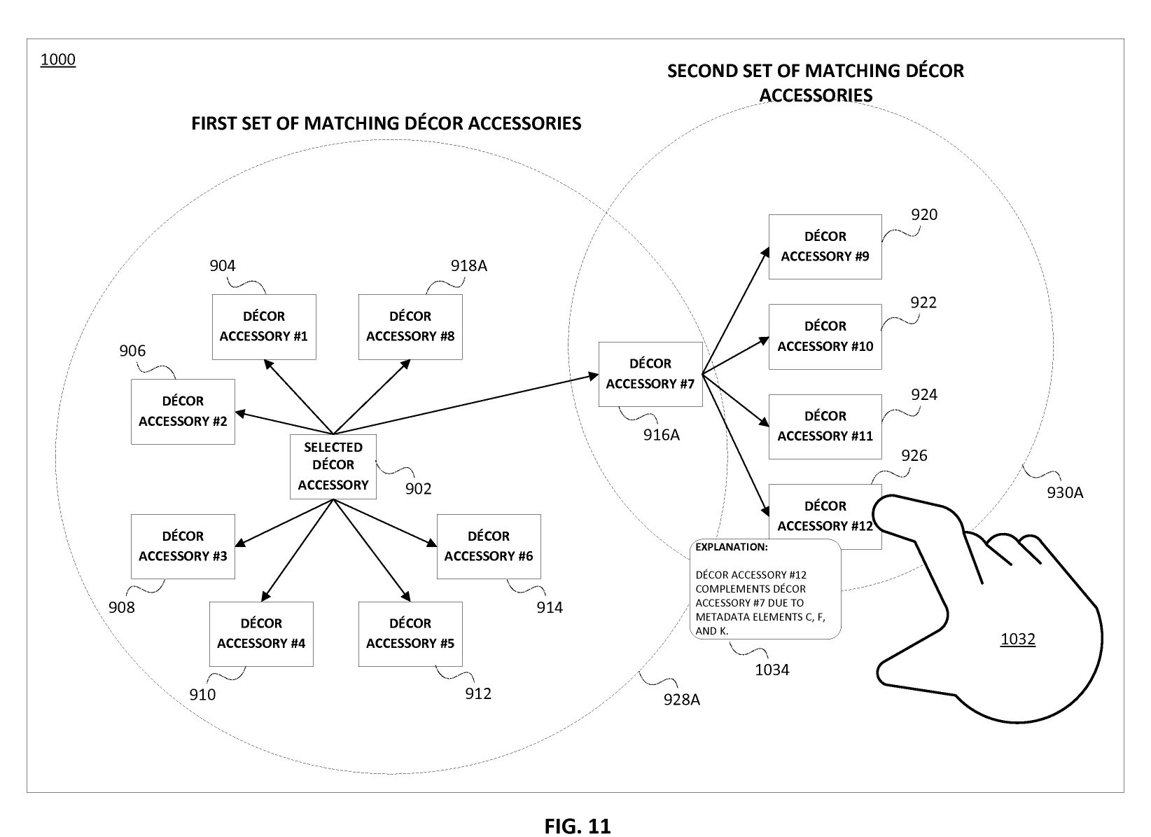

FIG. 11 is an example of a user 1032 interacting with a second set 930A of matching décor accessories. In various embodiments, the first set 928A of matching décor accessories is displayed on a GUI 1000. The first set 928A of matching décor accessories may be displayed, for example, using a plurality of nodes and one or more edges. The GUI 1000 can be implemented using an internet browser, an embedded application, a mobile application, etc. The graphical user interface may be configured to be displayed on a television, laptop, personal digital assistant (PDA), cellular phone, etc. In some embodiments, a user 1032 interacts with the GUI 1000 using one or more of a touchscreen, vocal commands, pointing device, keyboard, etc. For example, GUI 1000 illustrates the user 1032 applying pressure to a touchscreen interface over décor accessory 926. In some embodiments, the graphical user interface is configured to receive one or more user inputs and modify its appearance, the content displayed, etc., in response to the one or more user inputs. For example, if the user 1032 taps the GUI 1000 twice, the brightness may increase. In some embodiments, if the user 1032 selects a member (e.g., décor accessory 926) of the second set 930A of matching décor accessories, the GUI 1000 may be configured to display an explanation 1034. The explanation 1034 may describe one or more metadata elements that caused the match. In some embodiments, the explanation 1034 is input by a curator. Each explanation 1034 can describe the one or more identical or complementary metadata elements that cause each of the matching décor accessories (e.g., décor accessory 920, 922, 924, 926) to match the selected member (e.g., décor accessory 916A).

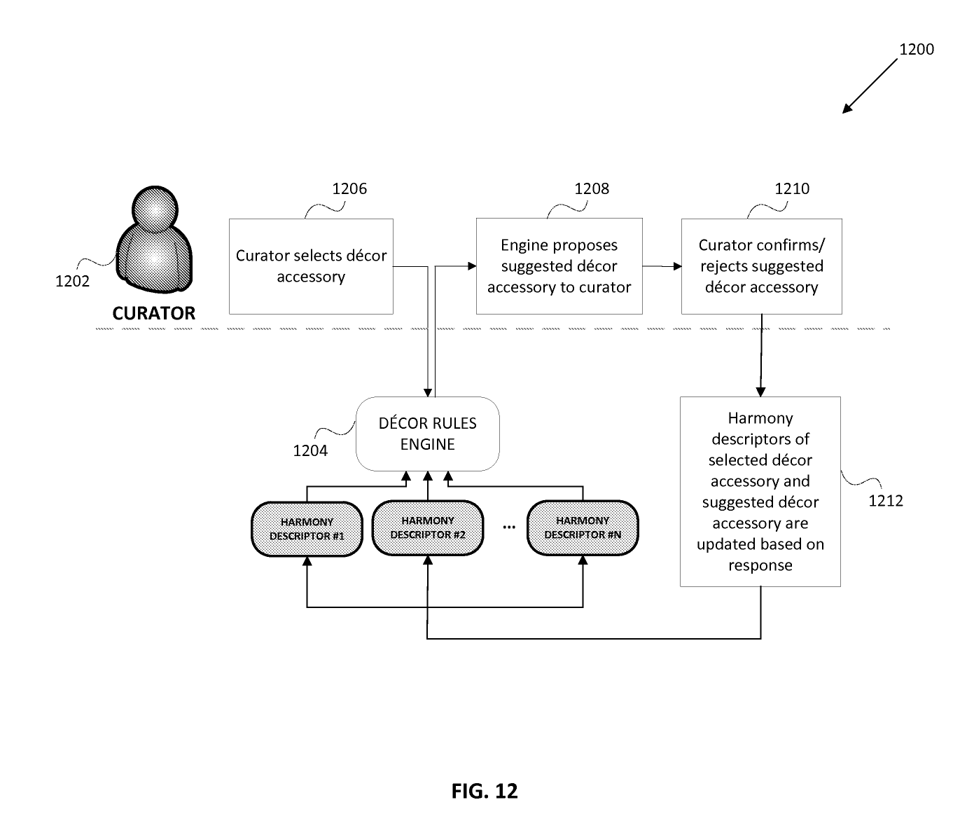

FIG. 12 is a block diagram illustrating a method for generating a harmonized décor scheme. In various embodiments, the method is implemented by a computer-implemented system (e.g., décor harmonizing system 800). The computer-implemented system can store metadata elements for a plurality of décor accessories. For example, metadata elements regarding various characteristics (e.g., color, mood, style) can be stored in a memory (e.g., memory 802) or a specified storage module (e.g., first storage module 804). In some embodiments, representations of the plurality of décor accessories can be stored in the memory (e.g., memory 802) or a specified storage module (e.g., first storage module 804).

At block 1206, the computer-implemented system can allow a creator (e.g., curator 1202) to choose a selected décor accessory from the plurality of décor accessories. Following a selection by the creator, the décor rules engine 1204 can determine whether metadata elements match based on a plurality of décor harmony rules. The décor harmony rules may generate matches based on RGB or hex triplet value, saturation level, hue level, color pixel density, hue-saturation-lightness (HSL) coordinate, hue-saturation-value (HSV) coordinate, feature-extraction, visualness, visual saliency, shape detection, etc. At block 1208, the computer-implemented system proposes a suggested décor accessory to match the selected décor accessory. At block 1210, the creator either confirms or rejects the suggested décor accessory as matching. The computer-implemented system can track whether the creator confirms or rejects the match. At block 1212, the computer-implemented system updates the harmony descriptors of the selected décor accessory and the suggested décor accessory based on the creator's response (i.e., confirmation or rejection). The computer-implemented system can, for example, implement this method using various modules shown in FIG. 8.

In some embodiments, the décor harmony rules include a harmony descriptor that identifies the suggested décor accessory as matching the selected décor accessory. The harmony descriptor may include one or more searchable metadata elements of the selected décor accessory and the suggested décor accessory that caused the décor rules engine 1204 to match the suggested décor accessory with the selected décor accessory. In various embodiments, the décor harmony rules implemented by the décor rules engine 1204 include a set of instructions for the computer-implemented system that describe why certain décor accessories form a matching set. For example, the décor rules may instruct the décor rules engine 1204 to determine whether one or more metadata elements of the selected décor accessory match one or more metadata elements of the suggested décor accessory. Matching metadata elements may include those metadata elements that are identical and/or those that are complementary. For example, the selected décor accessory and the suggested décor accessory may both include one or more shared, identical metadata elements (e.g., “Color: Bright Lavender,” “Mood: Calm,” “Style: Modern”) that cause the match. As another example, the selected décor accessory and the suggested décor accessory may include one or more complementary metadata elements that cause the match (e.g., “Color: Sand” complements “Color: Ocean Blue”). One skilled in the art will recognize that, although a limited number of examples have been described herein, many décor rules could be implemented by the computer-implemented system. In various embodiments, the décor rules recognize various relationships between the plurality of décor accessories based on searchable metadata elements belonging to each of the plurality of décor accessories.

In some embodiments, the computer-implemented system allows the creator (e.g., curator) to input an explanation if the creator confirms or rejects the suggested décor accessory as matching. For example, if the creator confirms the suggested décor accessory as matching, the creator can input an explanation that describes the one or more searchable metadata elements that cause the suggested décor accessory to match the selected décor accessory. Similarly, if the creator rejects the suggested décor accessory as matching, the creator can input an explanation that describes why the suggested décor accessory does not match the selected décor accessory. In some embodiments, the computer-implemented system stores the explanation into the harmony descriptor, thereby creating an updated harmony descriptor. In some embodiments, the computer-implemented system confirms that, if a user subsequently chooses the selected décor accessory, the suggested décor accessory is proposed as a match based on the confirmation by the creator. Similarly, the computer-implemented system can confirm that, if a user subsequently chooses the selected décor accessory, the suggested décor accessory is not proposed as a match based on the rejection by the creator.

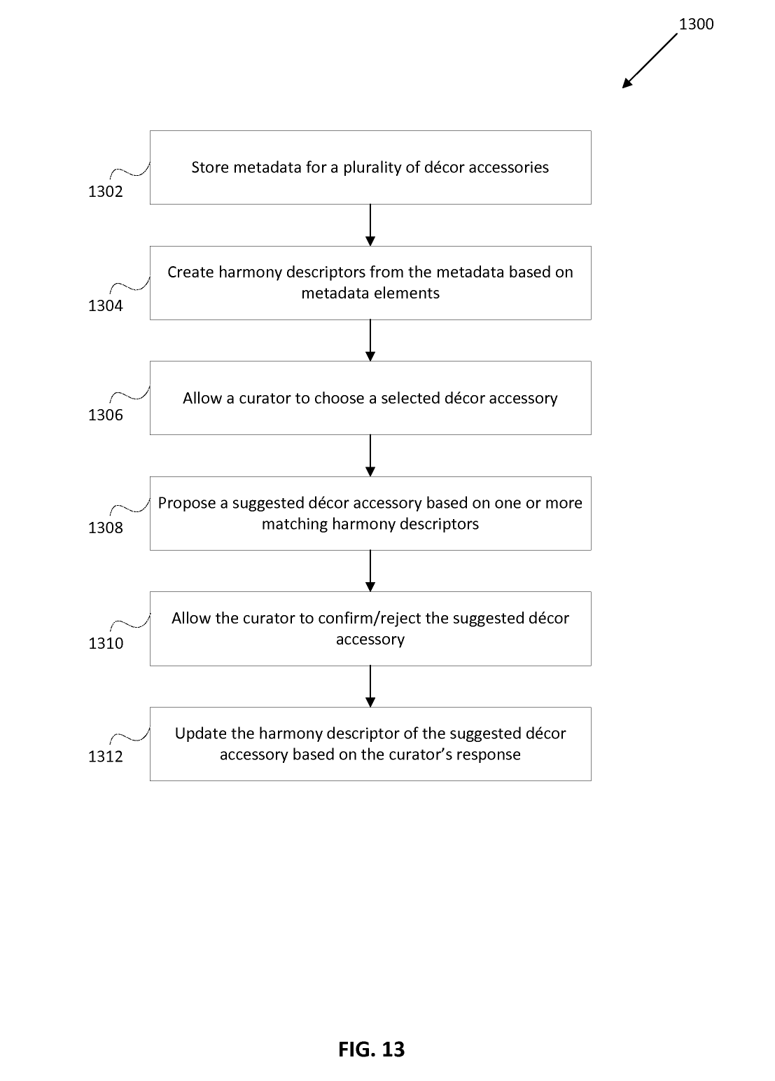

FIG. 13 is a flow diagram of a process 1300 for creating a harmonized set of décor accessories in accordance with various embodiments. In various embodiments, a system (e.g., décor harmonizing system 800) implements process 1300 for creating a harmonized set of décor accessories. At block 1302, the system stores metadata for a plurality of décor accessories. The metadata can include one or more metadata elements that describe various properties (e.g., color, style, tag) of each décor accessory. The one or more metadata elements can be stored in a memory (e.g., memory 802), a specialized module (e.g., first storage module 804), or some combination thereof. At block 1304, the system creates one or more harmony descriptors from the metadata elements. The harmony descriptors can identify matches between the plurality of décor accessories. The matches may be based on identical or complementary metadata elements. At block 1306, the system allows a creator to choose a selected décor accessory. The selected décor accessory may be selected from the plurality of décor accessories. At block 1308, the system proposes a suggested décor accessory based on one or more matching harmony descriptors. As described above, the matching harmony descriptors can identify identical or complementary metadata elements that cause the décor accessories to match. At block 1310, the system allows the creator to confirm or reject the suggested décor accessory as matching. Although the suggested décor accessory and the selected décor accessory may have one or more matching metadata elements, the creator may determine the décor accessories themselves do not match. For example, the suggested décor accessory and the selected décor accessory may include matching colors, but have different styles, moods, etc. At block 1310, the system can update the one or more harmony descriptors based on the creator's response. “Curator,” as that term is used herein, refers to one who creates and/or modifies harmony descriptors, metadata elements of décor accessories, sets of matching décor accessories, etc. For the purposes of this Detailed Description, “curator” and “creator” may be used interchangeably.

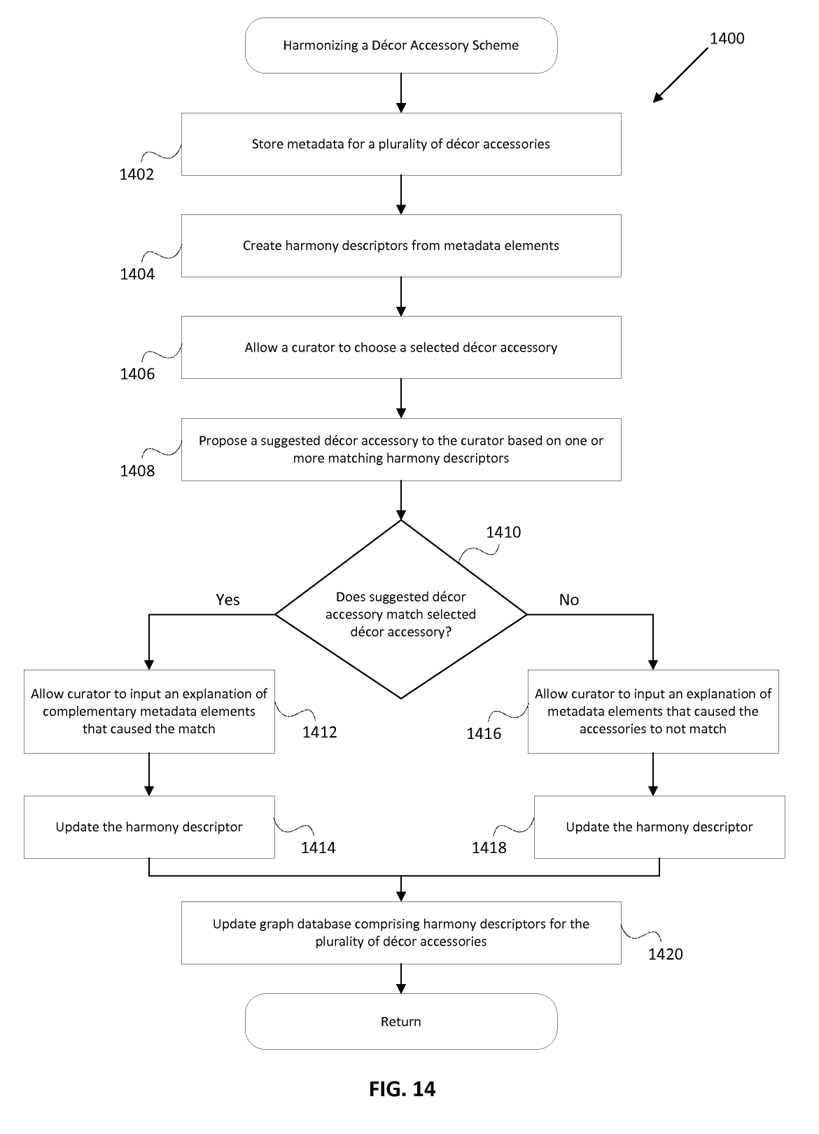

FIG. 14 is a flow diagram illustrating an example process 1400 of harmonizing a décor accessory scheme. In various embodiments, the process 1400 is executed by a system having various modules, such as décor harmonizing system 800 of FIG. 8. At block 1402, the system stores metadata for a plurality of décor accessories in a memory (e.g., memory 802). In some embodiments, the system may store the metadata using a specialized module (e.g., first storage module 804) or storage medium. At block 1404, the system creates one or more harmony descriptors from the metadata. In some embodiments, a harmony descriptor creation module creates the harmony descriptors belonging to each of the plurality of décor accessories. The metadata can include one or more searchable metadata elements that describe one or more of color, accent, visualness, mood, style, theme, etc.

At block 1406, the system implements a curation module (e.g., curation module 812) that allows a curator to choose a selected décor accessory. The curation module can allow the curator to select any of the plurality of décor accessories in the memory. In some embodiments, the curation module may limit which décor accessories can be selected by the curator. At block 1408, a rule module (e.g., rule module 814) proposes a suggested décor accessory to the curator that matches the selected décor accessory. The match can be based on a harmony descriptor belonging to the selected décor accessory. The harmony descriptor can include one or more searchable metadata elements of the selected décor accessory and the suggested décor accessory that causes the match. In various embodiments, the matching metadata elements are identical, complementary, or some combination thereof. At block 1410, a decision module permits the curator to confirm or reject the suggested décor accessory as matching the selected décor accessory. As described above, the curator can determine the suggested décor accessory and the selected décor accessory do not match, despite having one or more matching metadata elements.

At blocks 1412 and 1416, a confirmation module (e.g., confirmation module 820) or a rejection module (e.g., rejection module 822) allow the curator to input an explanation regarding the one or more metadata elements that caused the suggested décor accessory and the selected décor accessory to match or not match, respectively. For example, the curator may input an explanation that describes why a suggested décor accessory does not match despite having one or more matching metadata elements (e.g., identical color(s), but conflicting moods). At blocks 1414 and 1418, a second storage module (e.g., second storage module 806) can store the explanation into the harmony descriptor of the selected décor accessory and/or suggested décor accessory, thereby creating an updated harmony descriptor. In some embodiments, the second storage module is a distinct module or memory. In some embodiments, the first storage module and the second storage module are the same module. At block 1420, an update module (e.g., update module 832) can update the one or more harmony descriptors based on a response (i.e., confirmation or rejection) received from the curator.

In various embodiments, a database module (e.g., database module 826) can create, maintain, and/or update one or more harmony descriptors stored in a graph database based on the response (i.e., confirmation or rejection) received from the curator. In some embodiments, the database module includes a graph database that includes a plurality of nodes, properties, and edges. The graph database can include a set of nodes, each node having one or more properties, and one or more edges. Each node can represent one of the plurality of décor accessories, the one or more properties can represent one or more searchable metadata elements belonging to one of the plurality of décor accessories, and the one or more edges represent a match based on one or more harmony descriptors. In some embodiments, the distance between two or more nodes can be used as a measure or indication of harmony closeness (i.e., how much one décor accessory harmonizes with another). Details with respect to graph database are described at least with respect to FIGS. 9, 10, 11, 15A and 15B.

In various embodiments, the system includes an implementation module (e.g., implementation module 824). The implementation module can ensure that if, following a confirmation by the curator, a user subsequently chooses the selected décor accessory, the suggested décor accessory is proposed as a match. The implementation module can also ensure that if, following a rejection by the curator, a user subsequently chooses the selected décor accessory, the suggested décor accessory is not proposed as a match. One skilled in the art will recognize that the update module, database module, and implementation module can perform similar functions. Therefore, these modules may be joined to form one or more combined modules in some embodiments. In some embodiments, a user-selection module (e.g., user selection module 828) can receive a user selection of a user-selected décor accessory from the plurality of décor accessories. The user-selection module may allow the user to select any of the plurality of décor accessories or limit the select to a subset of the plurality of décor accessories. In some embodiments, a search module performs a search to identify one or more décor accessories that match the user-selected décor accessory. The match can be determined based on an updated harmony descriptor of the user-selected décor accessory, wherein the updated harmony descriptor identifies one or more matching metadata elements of the user-selected décor accessory and the matching décor accessory. Together, the user-selected décor accessory and the one or more matching décor accessories form a matching set of décor accessories.

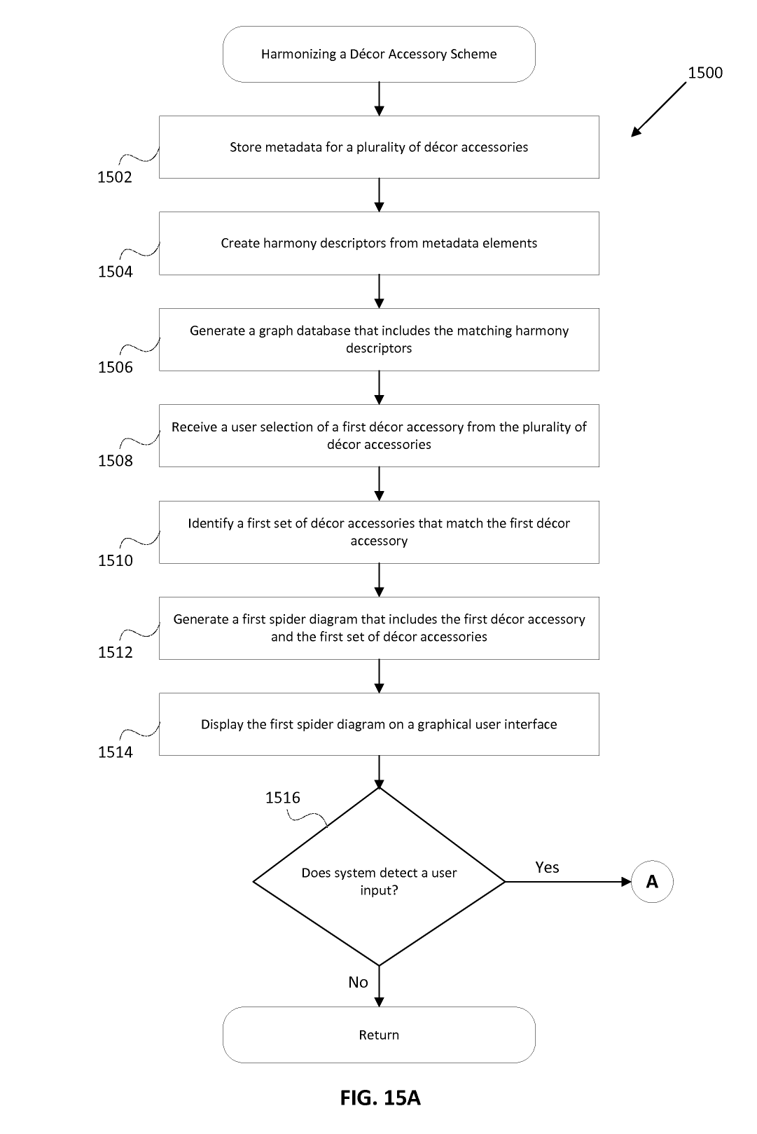

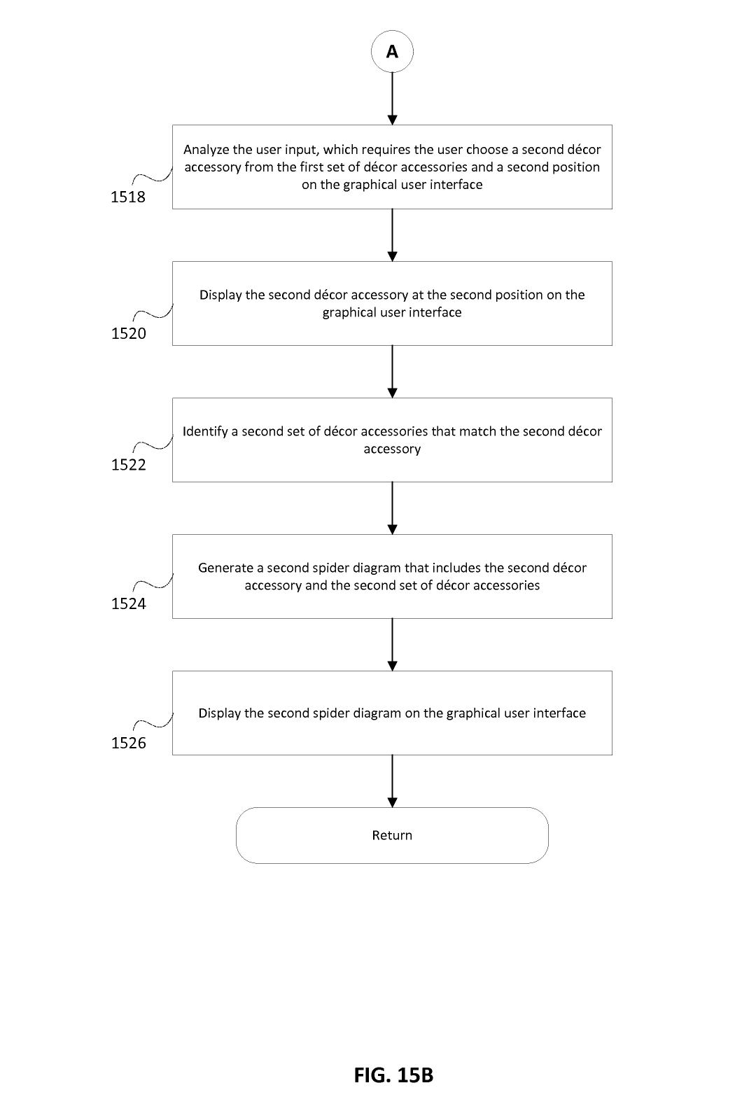

FIG. 15A is a flow diagram illustrating a process 1500 for harmonizing a décor accessory scheme. FIG. 15B is a continuation of the flow diagram of FIG. 15A. In various embodiments, the process 1500 is carried out by a set of program instructions that is implemented on a computer readable storage medium. The program instructions may, for example, utilize the various modules of décor harmonizing system 800 of FIG. 8. At block 1502, the program instructions store metadata for a plurality of décor accessories. The metadata, and the representations of the décor accessories themselves, can be stored in a memory. At block 1504, the program instructions create one or more harmony descriptors from metadata belonging to the plurality of décor accessories. The harmony descriptors can represent matching metadata elements between two or more of the plurality of décor accessories. The match may be based on similar or identical metadata elements, complementary metadata elements, or a combination thereof.

At block 1506, the program instructions generate a graph database that includes a set of nodes and one or more edges. Each node represents one of the plurality of décor accessories and can have one or more properties. The properties represent one or more searchable metadata elements belonging to one of the plurality of décor accessories. An edge represents a match between two or more décor accessories based on a harmony descriptor. Block 1506 may not exist in some embodiments (i.e., those that do not use a graph database). In such embodiments, the program instructions may generate, modify, etc., a non-graph database that includes information related to the plurality of décor accessories, metadata elements, harmony descriptors, etc.

At block 1508, the program instructions receive a user selection of a first selected décor accessory from the plurality of décor accessories. The user can select the first selected décor accessory in many ways. For example, the user may browse a list, select from a display on a GUI (e.g., GUI 500), enter a code corresponding to a particular décor accessory, etc. In some embodiments, the program instructions allow the user to select two or more décor accessories from the plurality of décor accessories. At block 1510, the program instructions identify a first set of décor accessories that match the first décor accessory. The match can be based on the one or more harmony descriptors of the first selected décor accessory. If the user selects more than one décor accessory, the first set of décor accessories will match all of the selected accessories. For example, if the user selects a first décor accessory (e.g., lamp) and a second décor accessory (e.g., painting), the system will identify a first set of décor accessories that match both selected accessories (i.e., the suggested and selected accessories form a matching set).

At block 1512, the program instructions generate a first spider diagram that includes the first selected décor accessory and the first set of matching décor accessories. The relationship(s) between the first selected décor accessory and each member of the first set of matching décor accessories can be shown in various ways. For example, the relationships may be illustrated as a mind map, a radar chart, a wheel and spokes diagram, genogram (i.e., family tree), etc. Each visual representation is intended to assist the user in understanding the connection(s), relationship(s), etc., between matching décor accessories. At block 1514, the program instructions display the first spider diagram on a GUI (e.g., GUI 1000). For example, FIG. 11 includes a first set 928A and a second set 930A of matching décor accessories displayed on a GUI 1000. At block 1516, the program instructions determine whether a user input has been detected by the system. The user input can include selecting a second décor accessory from the first set of décor accessories and a second position on the GUI. If the system does not detect a user input, the GUI continues to display the first spider diagram according to block 1514. If the system detects a user input, the GUI proceeds to block 1518.

At block 1518, the program instructions analyze the user input. More specifically, the program instructions determine which member of the first set of décor accessories was chosen as the second décor accessory and what location on the GUI was chosen as the second position. At block 1520, the program instructions display the second décor accessory at the second position on the graphical user interface. For example, FIG. 9 illustrates a second décor accessory (i.e., décor accessory 916A) displayed at a second position (i.e., no longer in the default position) on the GUI 1000.

At block 1522, the program instructions identify a second set of décor accessories that match the second décor accessory. The program instructions can identify the second set in a manner similar to how the first set was identified (i.e., program instructions initiate search for matches based on harmony descriptors). At block 1524, the program instructions generate a second spider diagram that includes the second décor accessory and the second set of décor accessories. The second spider diagram may be of the same type (e.g., both mind maps) as the first spider diagram, or the diagrams may be different. At block 1526, the program instructions display the second spider diagram on the GUI. For example, FIG. 9 illustrates a spider diagram that includes a second set 930A of décor accessories that match a second décor accessory (i.e., décor accessory 916A).

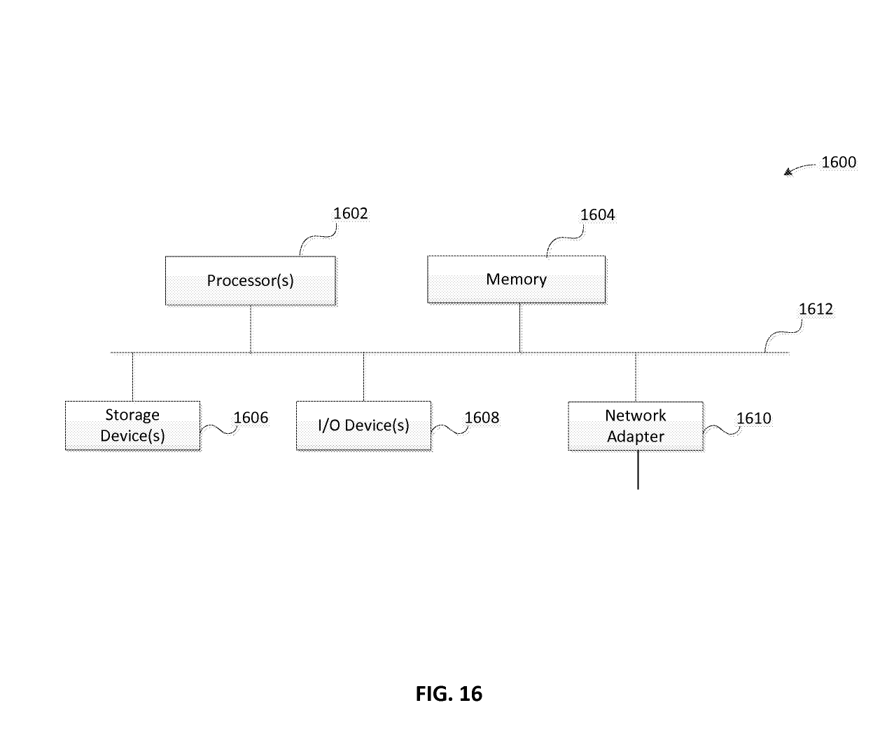

FIG. 16 is a block diagram illustrating an example of a computer system 1600 in which at least some operations described herein can be implemented, consistent with various embodiments. The computing system 1600 may include one or more central processing units (“processors”) 1602, memory 1604, input/output devices 1608 (e.g., keyboard and pointing devices, display devices), storage devices 1606 (e.g., disk drives), and network adapters 1610 (e.g., network interfaces) that are connected to an interconnect 1612. The interconnect 1612 is illustrated as an abstraction that represents any one or more separate physical buses, point to point connections, or both connected by appropriate bridges, adapters, or controllers. The interconnect 1612, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The memory 1604 and storage devices 1606 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, a point-to-point dial-up connection, etc. Thus, computer-readable media can include computer-readable storage media (e.g., “non-transitory” media) and computer-readable transmission media.

The instructions stored in memory 1604 can be implemented as software and/or firmware to program the processor(s) 1602 to carry out actions described above. In some embodiments, such software or firmware may be initially provided to the computer system 1600 by downloading it from a remote system through the computing system 1600 (e.g., via network adapter 1610).

The techniques introduced herein can be implemented by, for example, programmable circuitry (e.g., one or more microprocessors) programmed with software and/or firmware, or entirely in special-purpose hardwired (i.e., non-programmable) circuitry, or in a combination of such forms. Special-purpose circuitry can be in the form of, for example, one or more application-specific integrated circuits (ASICs), programmable logic devices (PLDs), field-programmable gate arrays (FPGAs) etc.

Software or firmware to implement the techniques introduced herein may be stored on a machine-readable storage medium and may be executed by one or more general-purpose or special-purpose programmable microprocessors. A “machine-readable medium,” as the term is used herein, includes any mechanism that can store information in a form accessible by a machine (e.g., computer, network device, cellular phone, PDA, manufacturing tool, any device with one or more processors). For example, a machine-accessible medium includes recordable/non-recordable media (e.g., read-only memory (ROM), random access memory (RAM), magnetic disk storage media, optical storage media, flash memory devices).

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the invention. For example, though the embodiments illustrate discovering décor accessories such as artworks, furniture, etc., the décor accessories are not limited to artworks or furniture. The décor accessories can include one or more paintings, pictures, artifacts, sound, architectural pieces, arrangement of artworks, color selection, rugs, mats, furnishings, clothes, jewelry, fashion, car interiors, flower arrangement, garden accessories, etc. Similarly, one skilled in the art will recognize that the methods and systems described herein could be used for any grouping(s) that involve a degree of aesthetic harmony subject to human taste (e.g., wine-food pairings). Accordingly, the invention is not limited except as by the appended claims.

Reference in this Detailed Description to “one embodiment” or “an embodiment” means that a particular feature, structure, or characteristic described in connection with the embodiment is included in at least one embodiment of the disclosure. The appearances of the phrase “in one embodiment” in various places throughout the Detailed Description are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the Detailed Description, to provide additional guidance to the practitioner regarding the description of the disclosure. For convenience, certain items may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein. Special significance is not to be placed upon whether or not a term is elaborated or discussed herein. Synonyms for certain terms are provided. A recital or one or more synonyms does not exclude the use of other synonyms. The use of examples anywhere in the Detailed Description, including examples of any term discussed herein, is illustrative only and is not intended to further limit the scope and meaning of the disclosure or of any exemplified term. Likewise, the disclosure is not limited to various embodiments given in the Detailed Description.

Those skilled in the art will appreciate that the logic illustrated in each of the flow diagrams discussed above may be altered in various ways. For example, the order of the logic may be rearranged, substeps may be performed in parallel, illustrated logic may be omitted, other logic may be included, etc.

Without intent to further limit the scope of the disclosure, examples of systems, apparatuses, method and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

What is claimed is:

1. A method comprising:
storing one or more harmony descriptors for at least some of a plurality of décor accessories, each of the harmony descriptors identifying one or more of the décor accessories matching a specified décor accessory of the plurality of décor accessories based on metadata of the plurality of décor accessories;
receiving a user selection of a first décor accessory from the plurality of décor accessories; and
performing a search to identify a first set of décor accessories that match the first décor accessory, the match determined based on a first harmony descriptor of the first décor accessory.

2. The method of claim 1, wherein the one or more harmony descriptors include a subset of metadata elements that cause the match.

3. The method of claim 1, wherein the metadata includes elements that describe one or more of a color, an accent, a visualness, a mood, a style, or a theme.

4. The method of claim 1, further comprising:
generating the first set of décor accessories that match the first décor accessory;
receiving a user selection of a member of the first set of décor accessories; and
presenting an explanation that describes one or more metadata elements that caused the member of the first set of décor accessories to match the first décor accessory.

5. The method of claim 4, wherein the explanation is input by a curator or a user.

6. The method of claim 1, further comprising:
retrieving, from a memory storage medium, information regarding previous user selections of members of the first set of décor accessories; and
analyzing the harmony descriptors of the first décor accessory, the one or more harmony descriptors of the plurality of décor accessories, and the information regarding previous user selections to identify the first set of décor accessories.

7. The method of claim 1, wherein the one or more harmony descriptors are generated automatically by a computer-implemented system, manually by a curator, or a combination thereof.

8. The method of claim 1, further comprising:
generating the first harmony descriptor of the first décor accessory, the harmony descriptor including one or more metadata elements shared by the first décor accessory and the first set of décor accessories, the one or more metadata elements causing the match;
receiving a user selection of a first metadata element; and
generating a filtered set of décor accessories that comprises those members of the first set of décor accessories that include the first metadata element.

9. The method of claim 2, wherein the one or more harmony descriptors of the plurality of décor accessories are stored in a graph database that comprises a set of nodes, each node having one or more properties, and one or more edges, wherein each node represents one of the plurality of décor accessories, the one or more properties represent the metadata elements of the décor accessories, and the one or more edges represent a match based on the one or more harmony descriptors.

10. The method of claim 9, further comprising:
receiving a user selection of a member of the first set of décor accessories, the member represented by a first node; and
performing a search to identify a second set of décor accessories that match the member selected from the first set of décor accessories, the match based on the harmony descriptor of the member selected from the first set of décor accessories,
wherein the second set of décor accessories is represented by a plurality of nodes and the harmony descriptor is represented by a plurality of edges connecting the first node to the plurality of nodes.

11. The method of claim 9, wherein the one or more edges further comprise a metadata element or explanation that qualitatively describes a connection between two nodes.

12. The method of claim 10, wherein the distance between the first node and one of the plurality of nodes indicates a level of harmony closeness.

13. A computer-implemented system for harmonizing a décor scheme comprising:
a first storage module, the first storage module storing metadata for a plurality of décor accessories;
a curation module, the curation module allowing a curator to choose a selected décor accessory from the plurality of décor accessories;
a rule module, the rule module proposing, based on a plurality of décor rules implemented by the computer-implemented system, a suggested décor accessory to match the selected décor accessory, wherein the décor rules include a harmony descriptor that identifies the suggested décor accessory as matching the selected décor accessory, and wherein the harmony descriptor includes metadata of the selected décor accessory and the suggested décor accessory that caused the décor rules to match the suggested décor accessory with the selected décor accessory;
a decision module, the decision module allowing the curator to confirm or reject the suggested décor accessory as matching with the selected décor accessory; and
an update module, the update module updating the harmony descriptor based on a response received from the curator.

14. The computer-implemented system of claim 13, wherein the harmony descriptor comprises one or more searchable metadata elements.

15. The computer-implemented system of claim 14, wherein the one or more searchable metadata elements describe one or more of a color, an accent, a visualness, a mood, a style, or a theme.

16. The computer-implemented system of claim 14, wherein the harmony descriptor is generated automatically by the system, manually by the curator, or a combination thereof.

17. The computer-implemented system of claim 14, further comprising:
a confirmation module, the confirmation module allowing, if the curator confirms the suggested décor accessory, the curator to input an explanation that describes the one or more searchable metadata elements that cause the suggested décor accessory to match the selected décor accessory; and
a second storage module, the second storage module storing the explanation into the harmony descriptor, thereby creating an updated harmony descriptor.

18. The computer-implemented system of claim 14, further comprising:
a rejection module, the rejection module allowing, if the curator rejects the suggested décor accessory, the curator to input an explanation that describes the one or more searchable metadata elements that cause the suggested décor accessory not to match the selected décor accessory; and
a second storage module, the second storage module storing the explanation into the harmony descriptor, thereby creating an updated harmony descriptor.

19. The computer-implemented system of claim 17, further comprising:
an implementation module, the implementation module ensuring that, if a user chooses the selected décor accessory, the suggested décor accessory is proposed as a match based on the confirmation by the curator.

20. The computer-implemented system of claim 18, further comprising:
an implementation module, the implementation module ensuring that, if a user chooses the selected décor accessory, the suggested décor accessory is not proposed as a match based on the rejection by the curator.

21. The computer-implemented system of claim 17, further comprising:
a database module, the database module updating a graph database that comprises a set of nodes, each node having one or more properties, and one or more edges, wherein each node represents one of the plurality of décor accessories, the one or more properties represent the one or more searchable metadata elements of the décor accessories, and the one or more edges represent a match based on one or more harmony descriptors.

22. The computer-implemented system of claim 18, further comprising:
a user-selection module, the user-selection module receiving a user selection of a first décor accessory from the plurality of décor accessories; and
a search module, the search module performing a search to identify a set of décor accessories that match the first décor accessory, the match determined based on the updated harmony descriptor of the first décor accessory.

23. A computer readable storage medium comprising program instructions for:
storing one or more harmony descriptors for at least some of a plurality of décor accessories, each of the harmony descriptors identifying one or more of the décor accessories matching a specified décor accessory of the décor accessories based on metadata of the décor accessories;
receiving a user selection of a first décor accessory from the plurality of décor accessories;
performing a search to identify a first set of décor accessories that match the first décor accessory, the match based on a first harmony descriptor of the first décor accessory; and
generating a first spider diagram that includes the first set of décor accessories that match the first décor accessory.

24. The computer readable storage medium of claim 23, wherein the first spider diagram is a mind map.

25. The computer readable storage medium of claim 23, wherein the first spider diagram is displayed on a graphical user interface.

26. The computer readable storage medium of claim 25, further comprising program instructions for:
generating the first spider diagram having a first position on the graphical user interface, the first spider diagram represented by a first plurality of nodes and a first plurality of edges connecting the first plurality of nodes;
detecting an input by the user, wherein the input comprises selection of a second décor accessory from the first set of décor accessories and a second position on the graphical user interface;
generating, in response to detecting the input, the second décor accessory at the second position on the graphical user interface, the second décor accessory represented by a focal node that is connected to at least one member of the first plurality of nodes by a focal edge; and
generating a second spider diagram that includes a second set of décor accessories chosen from the plurality of décor accessories that match the second décor accessory, the match based on a second harmony descriptor of the second décor accessory, the second spider diagram represented by a second plurality of nodes and a second plurality of edges connecting each of the second plurality of nodes to the focal node.

27. The computer readable storage medium of claim 26, further comprising program instructions for:
generating an explanation that describes the one or more searchable metadata elements that caused a selected member of the first or second set of décor accessories to match the first or second décor accessory.

28. The computer readable storage medium of claim 27, wherein the explanation is input by a curator.

29. A method for harmonizing a décor scheme comprising:
storing metadata for a plurality of décor accessories;
allowing a curator to choose a selected décor accessory from the plurality of décor accessories;
proposing, based on a plurality of décor rules implemented by the computer-implemented system, a suggested décor accessory to match the selected décor accessory, wherein the décor rules include a harmony descriptor that identifies the suggested décor accessory as matching the selected décor accessory, and wherein the harmony descriptor includes metadata of the selected décor accessory and the suggested décor accessory that caused the décor rules to match the suggested décor accessory with the selected décor accessory;
allowing the curator to confirm or reject the suggested décor accessory as matching with the selected décor accessory; and
updating the harmony descriptor based on a response received from the curator.

30. The method of claim 29, wherein the harmony descriptor comprises one or more searchable metadata elements.

31. The method of claim 30, wherein the one or more searchable metadata elements describe one or more of a color, an accent, a visualness, a mood, a style, or a theme.

32. The method of claim 30, wherein the harmony descriptor is generated automatically by the system, manually by the curator, or a combination thereof.

33. The method of claim 30, further comprising:
allowing, if the curator confirms the suggested décor accessory, the curator to input an explanation that describes the one or more searchable metadata elements that cause the suggested décor accessory to match the selected décor accessory; and
storing the explanation into the harmony descriptor, thereby creating an updated harmony descriptor.

34. The method of claim 30, further comprising:
allowing, if the curator rejects the suggested décor accessory, the curator to input an explanation that describes the one or more searchable metadata elements that cause the suggested décor accessory not to match the selected décor accessory; and
storing the explanation into the harmony descriptor, thereby creating an updated harmony descriptor.

35. The method of claim 33, further comprising:
confirming that, if a user chooses the selected décor accessory, the suggested décor accessory is proposed as a match based on the confirmation by the curator.

36. The method of claim 34, further comprising:
confirming that, if a user chooses the selected décor accessory, the suggested décor accessory is not proposed as a match based on the rejection by the curator.

37. The method of claim 33, further comprising:
updating a graph database that comprises a set of nodes, each node having one or more properties, and one or more edges, wherein each node represents one of the plurality of décor accessories, the one or more properties represent the one or more searchable metadata elements of the plurality of décor accessories, and the one or more edges represent a match based on one or more harmony descriptors.

38. The method of claim 33, further comprising:
receiving a user selection of a first décor accessory from the plurality of décor accessories; and
performing a search to identify a set of décor accessories that match the first décor accessory, the match determined based on the updated harmony descriptor of the first décor accessory.
